(19) United States
(12) Patent Application Publication
(10) Pub. No.: US 2022/0095646 A1
(43) Pub. Date: Mar. 31, 2022

(54) METHODS FOR THE PRODUCTION AND USE OF MYCELIATED AMINO ACID-SUPPLEMENTED FOOD COMPOSITIONS

(71) Applicant: MycoTechnology, Inc., Aurora, CO (US)

(72) Inventors: Bhupendra Kumar SONI, Aurora, CO (US); Anthony J. CLARK, Aurora, CO (US); Alan D. HAHN, Aurora, CO (US); James Patrick LANGAN, Aurora, CO (US); Brooks John KELLY, Aurora, CO (US); Brendan SHARKEY, Aurora, CO (US); Ashley HAN, Aurora, CO (US)

(73) Assignee: MycoTechnology, Inc., Aurora, CO (US)

(21) Appl. No.: 17/424,402

(22) PCT Filed: Jan. 24, 2020
(86) PCT No.: PCT/US2020/015010

§ 371 Date: Jul. 20, 2021

Related U.S. Application Data
(60) Provisional application No. 62/796,438, filed on Jan. 24, 2019.

(51) Int. Cl. A23J 3/14; A23L 33/175; A23L 33/185; A23L 31/00; A23J 3/26; A21D 2/26; A21D 2/24

(52) U.S. Cl. CPC A23J 3/14; A23L 33/175; A23L 33/185; A23L 31/00; A23V 2002/00; A21D 2/266; A21D 2/245; A21D 2/265; A23J 3/26

(57) ABSTRACT

Methods, and compositions derived thereof, for preparing a myceliated amino-acid-supplemented high-protein food product having desired digestibility and amino acid content. An aqueous medium comprising a high-protein material is inoculated with a fungal culture to produce a myceliated amino acid-supplemented high-protein food product. The plant protein can include pea, rice and/or chickpea protein. The fungi can include Lentinula spp., Agaricus spp., Pleurotus spp., Boletus spp., or Laetiporus spp. Preferably, the myceliated amino acid-supplemented high-protein food product has reduced bitterness and/or reduced volatile amino-acid-derived aroma compared to high-protein amino acid-supplemented material that is not myceliated. Also disclosed are myceliated amino-acid-supplemented high-protein food products and compositions, such as dairy alternative products, beverages and beverage bases, extruded and extruded/puffed products, meat analogs and extenders, baked goods and baking mixes, texturized plant-based protein products, granola products, bar products, smoothies and juices, and soups and soup bases.

### CROSS RELATED APPLICATIONS

This application claims priority to and the benefit of U.S. Provisional Application Ser. No. 62/796,438, filed Jan. 24, 2019, which is incorporated herein by reference in its entirety.

### BACKGROUND OF INVENTION

There is a growing need for efficient, high quality and low-cost high-protein food sources from plants. Plant-sourced proteins offer environmental and health benefits. However, plant-based proteins have less of an anabolic effect than animal proteins due to their lower digestibility, lower essential amino acid content (especially leucine), and deficiency in other essential amino acids, such as sulfur amino acids (SAA) or lysine.

To address the deficiencies in the essential amino acid profiles of certain plant proteins, such as pea protein concentrates made using conventional processing techniques, producers have resorted to blending together concentrates derived from different protein sources (with different limiting amino acid compositions) to create a product which has a blended amino acid profile that meets the industry standards for a complete amino acid profile. For example, typically companies would blend pea and rice proteins together, as rice is high in sulfur-containing amino acids and low in lysine; whereas, pea is high in lysine and low in sulfur-containing amino acids. Alternatively, to improve plant-source proteins, producers have also tried to supplement these materials with amino acids, in order to increase their nutritional value. For example, to mimic the high branched chain amino acid (BCAA) profiles and functional characteristics of whey protein in other protein sources having lower amounts of BCAA, manufacturers can add one or more BCAA (e.g., one or more of the BCAA amino acids) to the protein products to mimic the levels of one or more of the BCAA found in whey. For example, nutritional products can contain branched-chain amino acids (BCAAs) such as L-leucine, L-isoleucine, and L-valine.

Pea protein is known in the art to be limiting in methionine and the literature shows that the nutritional value of pea protein is improved with methionine supplementation (Keith, M. O. et al., 1977, “The supplementation of pea protein concentrate with DL-methionine or with methionine hydroxy analog,” Canadian Institute of Food Science and Technology J., Vol. 10 pp 1-4.) Wheat gluten is similarly low in lysine.

However, it is known in the art that free amino acids or amino acid salts tend to impart a taste, flavor or aroma, including to the foods they are added to. See, e.g., Schiffman, S. and Dackis, C. 1975 “Taste of nutrients: amino acids, vitamins, and fatty acids,” Perception and Psychophysics Vol. 17(2), 140-146. For example, branched chain amino acids are known to have bitter tastes and strong, unpleasant odors. Sulfur amino acids (SAAs), such as methionine and cysteine, are also perceived as quite unpleasant. For example, methionine is described as having a taste that is very repulsive, metallic, mineral, bitter and induces nausea. Cysteine is described as strong, concentrated and nausea-inducing, compared to sewage, rotten eggs and sulfur, and bitter. Another amino acid, lysine, which is deficient in wheat gluten, is described as salty and bitter with a sharp component.

BCAA in particular not only have a bitter taste but also provide strong, unpleasant odors, leading to low palatability. Leucine, which is considered to be the most effective of the three BCAAs at promoting muscle protein synthesis, is also the most bitter. As a result, the higher the leucine concentration, the more bitter and unpalatable the product becomes. Not only are BCAAs bitter, but their amino acid breakdown include branched chain fatty acid volatiles (isobutyric acid from valine, isovaleric acid from leucine, and 2-methyl butyric acid from isoleucine). These materials carry off-flavors; isovaleric acid (foot odor, rancid cheese), isobutyric acid (acidic, sour, cheesy, dairy, buttery, rancid); and 2-methyl butyric acid (acidic, fruity, dirty, cheesy, fermented). Other volatiles resulting from BCAA include dimethyl sulfide (DMS) (cooked cabbage odor), 3-methyl butanal, 2-methyl butanal (malty flavor) and methional (potato chip flavor), and others.

Branched chain amino acids (BCAAs), namely, leucine, isoleucine and valine are believed to have the beneficial functions of enhancing protein anabolism and muscle synthesis during post-workout period. Supplementation with BCAAs has been found to spare lean body mass during weight loss, promote wound healing, may decrease muscle wasting with aging, and may have beneficial effects in renal and liver disease.

Whey protein is one of the richest sources of BCAAs. Protein products made from whey include whey protein concentrates (WPC 80) or whey protein isolates (WPI). High-BCAA protein products are commonly used as ingredients in the food industry due to their exceptional functional and nutritional characteristics. However, the usage of these products has been limited by their flavor. The flavor of whey is one of the limiting factors in its wide spread usage. Whey proteins exhibited sweet aromatic, cardboard/wet paper, animal/wet dog, soapy, brothy, cucumber, and cooked/milky flavors, along with the basic taste bitter, and the feeling factor astringency.

Traditionally, to improve the palatability of these nutritional products supplemented with amino acids, such as those containing BCAA, manufacturers rely on addition of flavored powders containing various kinds of tastants (sucrose, citric acid, etc.) and odorants (fruit, coffee aromas, etc.). The most commonly used method to reduce bitterness in BCAA-based nutritional beverages is the addition of a combination of sweeteners and acids, such as sucralose, stevia and citric acid at high levels.

There is therefore a need for efficient, high quality and low cost high-protein food sources, ideally from plants, containing amino acid profiles that provide more complete protein profiles and/or mimic one or more animal proteins, such as whey. For example, one needed product is a plant protein with a BCAA profile similar to whey, but with acceptable taste, flavor and/or aroma profiles, and for a process that enables production of such a product.

### SUMMARY OF THE INVENTION

In an embodiment, the present invention includes a method to prepare a myceliated amino-acid-supplemented high-protein food product. This method includes the following steps: providing an aqueous medium comprising a high-protein material, wherein the aqueous medium comprises at least 50% (w/w) protein on a dry weight basis, wherein the media comprises at least 50 g/L protein, wherein the media is supplemented with at least one exogenous amino acid in an amount that results in an increase in the total wt % of the at least one amino acid in the high-protein material by at least 1%, and wherein the high protein material is from a plant source; inoculating the medium with a fungal culture, wherein the fungal culture comprises Lentinula edodes, Agaricus spp., Pleurotus spp., Boletus spp., or Laetiporus spp., and culturing the medium to produce a myceliated amino acid-supplemented high-protein food product; wherein the myceliated amino acid-supplemented high-protein food product has reduced bitterness, and/or reduced metallic flavor, and/or reduced mineral flavor, and/or reduced volatile amino-acid-derived aroma compared to the high-protein amino acid-supplemented material that is not myceliated.

The present invention also includes a composition comprising a myceliated amino acid-supplemented high-protein food product, wherein the myceliated amino acid-supplemented high-protein food product is at least 50% (w/w) protein on a dry weight basis, wherein the myceliated amino acid-supplemented high protein food product is derived from a plant source, wherein the myceliated amino acid-supplemented high protein product is myceliated by a fungal culture comprising Lentinula edodes, Agaricus blazeii, Pleurotus spp., Boletus spp., or Laetiporus spp. in a media comprising at least 50 g/L protein, wherein the amino acid-supplemented high-protein food product has additional exogenous amino acid in an amount that is an increase in the total wt % of amino acid over the original endogenous amount of at least 1% and wherein the myceliated amino acid-supplemented high protein food product has reduced bitterness and/or reduced metallic flavor and/or reduced mineral flavor and/or reduced volatile amino acid derived aroma compared with a non-myceliated amino acid-supplemented food product.

The present invention also includes a method to prepare a myceliated amino acid-supplemented high-protein food composition. In this embodiment, the method includes the following steps: (a) providing a myceliated amino acid-supplemented high protein food product, comprising: (i) providing an aqueous medium comprising a high-protein material, wherein the aqueous medium comprises at least 50% (w/w) protein on a dry weight basis, wherein the media comprises at least 50 g/L protein, wherein the media is supplemented with at least one amino acid in an amount that results in an increase in the total wt % of the at least one amino acid in the high-protein material by at least 1%, and wherein the high protein material is from a plant source; (ii) inoculating the medium with a fungal culture, wherein the fungal culture comprises Lentinula edodes, Agaricus spp., Pleurotus spp., Boletus spp., or Laetiporus spp., and (iii) culturing the medium to produce a myceliated amino acid-supplemented high-protein food product. In embodiments, the myceliated amino acid-supplemented high-protein food product has reduced bitterness and/or reduced metallic flavor and/or reduced mineral flavor and/or reduced volatile amino acid-derived fatty acid flavor compared to the high-protein amino acid-supplemented material that is not myceliated. The method further comprises the steps of (b) providing an edible material; and (c) mixing the myceliated amino acid-supplemented high-protein food product and the edible material to form the food composition.

### DETAILED DESCRIPTION OF THE INVENTION

In general, the terms and phrases used herein have their art-recognized meaning, which can be found by reference to standard texts, journal references and contexts known to those skilled in the art. The following definitions are provided to clarify their specific use in the context of the invention.

Amino acids that humans cannot make must be obtained from outside sources, e.g. by eating food. Nine essential amino acids include methionine, lysine, leucine, isoleucine, valine, phenylalanine, tryptophan, threonine, and histidine. A complete protein contains all nine essential amino acids in the correct proportions for human nutrition, whereas an incomplete protein does not have enough of one or more of the essential amino acids. Additionally, a food can contain complete protein (all amino acids meet or exceed their respective ratios), but due to digestibility favors, the PDCAAS of the food may be less than one. The protein digestibility factor is referred to as a percent or a value (0.79 factor=79%). The PDCAAS may be calculated by amino acid score multiplied by recipe protein digestibility, where recipe protein digestibility is e.g. determined by pig studies using a specific diet. Apparent digestibility is corrected using the losses during the feeding process. PDCAAS values, in one embodiment, can be calculated using the recommended AA scoring pattern for preschool children (2 to 5 yr). The indispensable AA reference patterns for age 2 to 5 yr are expressed as mg AA/g protein: His, 19; Ile, 28; Leu, 66; Lys, 58; Sulphur AA, 25; Aromatic AA, 63; Thr, 34; Trp, 11; Val, 35 (FAO, 1991). PDCAAS values, in another embodiment, can be calculated using the recommended AA scoring pattern for a child (6 mo to 3 yr). The indispensable AA reference patterns for a child are expressed as mg AA/g protein: His, 20; Ile, 32; Leu, 66; Lys, 57; Sulphur AA, 27; Aromatic AA, 52; Thr, 31; Trp, 8.5; Val, 40 (FAO, 2013).

The Protein Digestibility Corrected Amino Acid Score (PDCAAS) is a method recognized by the US Food and Drug Administration and the World Health Organization for evaluating the protein quality of different foods and food ingredients based on the amino acid requirements of humans and the ability of humans to digest those foods and food ingredients to effectively make use of the amino acid content. Foods are evaluated on a scale of 0 to 1 with 1 being the highest. While compositions can have protein qualities in excess of 1.00 standard practice is to truncate the score to 1.00.

Determination of PDCAAS is as follows: PDCAAS amino acid score×fecal true digestibility percentage.

Animal based proteins such as casein, whey and egg white score 1.00 on the PDCAAS scale with plant-based proteins typically having lower scores. For example, whole wheat has a score of 0.42 and legumes, fruits and vegetables having scores ranging from about 0.70 to 0.78.

In an embodiment, the plant proteins may be supplemented with amino acids to produce a very high-quality protein product as measured by the PDCAAS method. Thus, in this embodiment, the composition is desired to have a PDCAAS protein quality of 0.95 or greater with a quality of 0.98 or greater being preferred and a quality of 1.00 or greater being most preferred. Those of ordinary skill would be able to determine different ratios of the component proteins and which amino acids to add and in what quantity, but in this embodiment, in general it is desired that a composition has a PDCAAS protein quality score of 1.00 or greater.

In another embodiment, in the present invention, the percentages of one or more amino acids, such as PDCAAS, may be adjusted to yield a plant protein with more similarity in the amount of one or more essential AAs, such as BCAAs, to an animal-based protein, for example, whey. The PDCAAS may exceed the requirements in this embodiment. Whey, in particular, has a high level of branched chain amino acids (BCAAs), namely, leucine, isoleucine and valine, content. This content is approximately 241 mg BCAA per gram protein in whey, and in particular, whey (WPC, 80%) has an amount of BCAA of 192 mg/g total weight. The content of leucine is about 102 mg/gram protein, and in 80% WPC the total leucine is 81.6 mg/g total weight. U.S. Dairy Council 2004. The BCAA are three of the nine essential amino acids and account for 35 to 40% of the dietary indispensable amino acids in body protein and 14% of the total amino acids in skeletal muscle. BCAA are neutral amino acids with a branched chain of aliphatic hydrocarbon on an a-carbon. BCAAs mainly metabolize in skeletal muscle, accounting for 35 percent of the essential amino acids in muscle proteins.

BCAAs are believed to have the beneficial functions of anti-fatigue, improving protein synthesis, enhancing immunity, extending life span, and, in particular, resisting muscle breakdown and nutrient loss, increasing muscle compression resistance, and enhancing protein anabolism and muscle synthesis during post-workout period. Supplementation with BCAAs has been found to spare lean body mass during weight loss, promote wound healing, may decrease muscle wasting with aging, and may have beneficial effects in renal and liver disease. Recent nutritional investigations have demonstrated that BCAA supplementation before and following exercise reduces the effects of muscle damage and accelerates muscle recovery during periods of sustained high intensity exercise. Leucine, in particular, is a BCAA that initiates muscle protein synthesis and recovery, as well as inhibiting muscle protein breakdown after strenuous endurance exercise.

Whey protein is one of the richest sources of BCAAs. Protein products made from whey include whey protein concentrates (WPC 80) or whey protein isolates (WPI). High-BCAA protein products are commonly used as ingredients in the food industry due to their exceptional functional and nutritional characteristics. However, the usage of these products has been limited by their flavor. The flavor of whey is one of the limiting factors in its wide spread usage. Whey proteins exhibited sweet aromatic, cardboard/wet paper, animal/wet dog, soapy, brothy, cucumber, and cooked/milky flavors, along with the basic taste bitter, and the feeling factor astringency.

In one embodiment, the invention includes wherein the leucine is enhanced by exogenous supplementation to a level of about 150 mg/g to yield an increased amount of leucine compared with, for example, the starting amount in the plant protein. In one non-limiting example, the amount of leucine in a plant protein mixture (such as pea/rice), for example, is 109 mg/g and it is supplemented to about 150 mg/g. The amount of leucine to achieve can be 80%, 85%, 90%, 95%, 100%, 105%, 110%, 120%, 130%, 140% of either 150 mg/g protein; the amount of leucine in an animal protein, such as whey; or the total amount of BCAA in an animal protein, such as whey.

In one embodiment, the myceliated amino-acid-supplemented high protein food product has exogenously added BCAA, such as leucine, in one embodiment, in an amount that is at least 95% of the amount of BCAA in an animal food, such as whey. In one embodiment, the protein originates only from plant-based sources, and has a flavor profile that includes, for example, reduced bitterness, and reduced volatile BCAA-derived fatty acid flavor, such as reduced “isovaleric” volatile notes. In an embodiment, the amount of BCAA to add will not necessarily result in an increase in PDCAAS but may achieve an amount of BCAA content in a plant protein which is similar to an animal protein, e.g., whey protein and provides a blood amino acid profile over 120 minutes (initial marker of Muscle Protein Synthesis success criteria) similar to whey protein or improved over whey protein as described elsewhere herein and improved over controls (no added BCAA.)

In an embodiment, a fermented plant protein (without amino acid supplementation) as prepared in Examples 2-4 was tested for values for apparent ileal digestibility (AID) and standardized ileal digestibility (SID) of crude protein (CP) and AA were calculated, and standardized total tract digestibility (STTD) of CP were calculated as well. See Example 20. Average values for basal endogenous losses of CP and AA used to calculate SID values, in addition, an average value for basal endogenous losses of CP were calculated from 2 previously conducted experiments in our laboratory to calculate STTD. Values for PDCAAS were calculated from the standardized total tract digestiblity of crude protein in pigs: pea-rice protein, 94.59%; fermented pea/rice protein (prepared by the method of Examples 2-4), 99.90%. The standardized total tract digestiblity of crude protein was calculated by correcting apparent total tract digestiblity (ATTD) of crude protein for the basal endogenous loss of CP, 16.61 g/kg dry matter intake. The ATTD of crude protein for pea-rice protein was 82.72% and 88.44% for fermented protein (Examples 2-4). Accordingly, one of skill in the art can take into account the increased digestibility of the fermented protein in determining the amount of exogenous amino acid(s) to add to yield the desired PDCAAS and/or desired amount of BCAA/leucine for a particular plant protein or mixture thereof. The formula to determine STTD of CP from ATTD of CP is as follows: STTD, %=ATTD+[(basal CPend/CP_{diet})×100]; where basal CP_{end} represents the basal endogenous losses of CP (% dry matter). The CP_{diet} represents the crude protein concentration in the diet (dry matter basis). Therefore, to calculate the STTD of CP for the fermented protein (Examples 2-4), the equation had the following values: STTD, %=88.44%+[(1.66/14.49)×100].

In the instant invention, the inventors have achieved, in one embodiment, the provision of a vegetarian, vegan source of protein that has enhanced amounts of one or more essential amino acids, either to match a particular animal source protein (such as whey, for example) and/or to provide a PDCAAS that is nearer to 1 than the original plant protein. Adding exogenous amino acids, particularly the BCAAs, the SAAs, or lysine, to a vegan/vegetarian protein material, in order to enhance their PDCAAS and/or to mimic a particular animal protein, tends to impart undesirable flavors/aromas to the vegan/vegetarian protein material as described elsewhere herein. However, the present inventors have found that a fermentation step as disclosed herein can mitigate and/or reduce the unpleasant flavor/aroma notes provided by the exogenously added amino acids.

Additionally, the instant invention provides improved organoleptics over the control materials, namely, decreased bitterness, metallic, and/or minerally flavor (by sensory testing) and reduced sensory attributes related to amino acid (valine, leucine and isoleucine) breakdown products which include branched chain fatty acid volatiles.

In embodiments, the exogenously added BCAA, such as leucine, can be added in an amount that is at least 75%, at least 80%, at least 85%, at least 90%, at least 95%, at least 100%, at least 110%, at least 120%, at least 130%, at least 140%, at least 150% or more of the amount of leucine (BCAA) in an animal food, such as whey.

In an embodiment, the myceliated amino-acid-supplemented high protein food product has exogenous SAA added, such as methionine, in an amount that provides, optionally, a plant protein that is deficient in SAA a higher PDCAAS score, such as at least 0.95. In one embodiment, the protein originates only from plant-based sources, and has a flavor profile that includes, for example, reduced bitterness, reduced metallic and/or mineral flavor; and/or reduced sewage, rotten eggs and sulfur flavor and/or aroma.

In embodiments, the exogenously added SAA, such as methionine, can be added in an amount that is at least 85%, at least 90%, at least 95%, at least 98%, at least 100%, at least 105%, or at least 110%, of the amount of PDCAAS to reach a level of about 1. A combination of sulfur amino acids, such as cysteine and methionine, can also supplemented.

In an embodiment, the myceliated amino-acid-supplemented high protein food product has exogenous lysine added, in an amount that provides, optionally, a food comprising one or more plant proteins, including a plant protein that is deficient in lysine (such as wheat gluten), a higher PDCAAS score, where the protein component of the food has improved PDCAAS. In one embodiment, the food is a food that comprises wheat gluten, which has a low PDCAAS due to deficiency in lysine. An additional plant protein which has had an amount of lysine added to the plant protein, that when added to a food comprising gluten, will increase the overall PDCAAS of the food. In one embodiment, the myceliated amino-acid-supplemented high protein food product originates only from plant-based sources, and has a flavor profile that includes, for example, reduced bitterness, reduced salty flavor, reduced mineral flavor, reduced metallic flavor.

In embodiments, the exogenously added lysine, can be added in an amount that is at least 70%, at least 75%, at least 80%, at least 85%, at least 90%, at least 95%, at least 98%, at least 100%, at least 105%, or at least 110%, of the amount of PDCAAS to reach a level of about 1 for a composition that is the combination of wheat gluten and wheat flour, and the myceliated amino-acid supplemented high protein product, as described elsewhere herein.

In embodiments, the at least one amino acid for exogenous supplementation can include any essential amino acid, in any combination, for example, BCAA supplementation together with SAA supplementation, for example.

The exogenous amino acids are preferably food-grade and may be used in their uncharged form or in charged form, optionally, in a salt form. When aqueous, amino acids can react with each other in a typical acid-base neutralization reaction to form a salt. Amino acid salts can be generally described as simple amino acid salts, salts of amino acids with dimeric cations, mixed salts of amino acids with different anions and cations, mixed amino acid metal salt complexes, amino acid-phosphoric acid complex salts and the like.

Accordingly, the present invention includes a method to prepare a myceliated amino acid-supplemented high-protein food product. The method may include the following steps. First, there is provided an aqueous medium comprising an amino-acid-supplemented high-protein material, wherein the aqueous medium comprises at least 50% (w/w) protein on a dry weight basis, wherein the media comprises at least 50 g/L protein, wherein the media is supplemented with at least one exogenous amino acid to a level to achieve a PDCAAS of 0.95 or above to the high protein material, and/or to achieve 95% or more of the level of one or more of an essential amino acid present in an animal food, such as whey. In an embodiment, the high protein material is from a plant source.

The aqueous media may comprise, consist of, or consist essentially of a high-protein material. The high-protein material to include in the aqueous media can be obtained from a number of sources, including vegetarian sources (e.g., plant sources) as well as non-vegetarian sources, and can include a protein concentrate and/or isolate. Vegetarian sources include meal, protein concentrates and isolates prepared from a vegetarian source such as pea, rice, chickpea, soy, cyanobacteria, hemp, chia, potato protein, wheat gluten, and other sources, or a combination thereof. For example, cyanobacteria containing more than 50% protein can also be used a source of high-protein material. Typically, a protein concentrate is made by removing the oil and most of the soluble sugars from a meal, such as soybean meal. Such a protein concentrate may still contain a significant portion of non-protein material, such as fiber. Typically, protein concentrations in such products are between 55-90%. The process for production of a protein isolate typically removes most of the non-protein material such as fiber and may contain up to about 90-99% protein. A typical protein isolate is typically subsequently dried and is available in a powdered form and may alternatively be called “protein powder.”

In one embodiment, mixtures of any of the high-protein materials disclosed can be used to provide, for example, favorable qualities, such as a more complete (in terms of amino acid composition) high-protein material. In one embodiment, high-protein materials such as pea protein and rice protein can be combined. In one embodiment, the ratio of a mixture can be from 1:10 to 10:1 pea protein: rice protein (on a dry basis). In one embodiment, the ratios can optionally be 5:1 to 1:5, 2:1 to 1:2, or in one embodiment, 1:1. Alternatively, in embodiments, the ratio can include mixtures that are 35% pea protein and 65% rice protein; 40% pea protein and 60% rice protein; 45% pea protein and 55% rice protein; 50% pea protein and 50% rice protein; 55% pea protein and 45% rice protein; 60% pea protein and 40% rice protein; 65% pea protein and 35% rice protein; 70% pea protein and 30% rice protein; 75% pea protein and 25% rice protein; or 80% pea protein and 20% rice protein. In another embodiment, the high protein material is not combined with another type of plant protein, and instead, the high protein is amended to increase the PDCAAS and/or bring the amount of at least one amino acid to 95% or more of the amount in an animal protein, such as whey.

In one embodiment, the present invention includes a method to prepare a myceliated amino-acid-supplemented high-protein food product, comprising the steps of: providing an aqueous medium comprising a high-protein material, wherein the aqueous medium comprises at least 50% (w/w) protein on a dry weight basis, wherein the media comprises at least 50 g/L protein, wherein the media is supplemented with at least one exogenous amino acid comprising leucine in an amount that results in an increase in leucine in the high-protein food product to at least about 140 mg/g protein, and wherein the high protein material is from a plant source comprising pea, rice or combinations thereof; inoculating the medium with a fungal culture, wherein the fungal culture comprises Lentinula edodes; and culturing the medium to produce a myceliated amino acid-supplemented high-protein food product; wherein the myceliated amino acid-supplemented high-protein food product has reduced bitterness and/or reduced volatile amino-acid-derived aroma compared to the high-protein amino acid-supplemented material that is not myceliated.

In embodiments, the present invention includes a method to prepare a myceliated amino-acid-supplemented high-protein food product, comprising the steps of: providing an aqueous medium comprising a high-protein material, wherein the aqueous medium comprises at least 50% (w/w) protein on a dry weight basis, wherein the media comprises at least 50 g/L protein, wherein the media is supplemented with at least one exogenous amino acid comprising methionine in an amount that results in an increase in methionine in the high-protein food product to yield a PDCAAS of 0.9, 0.95, or 0.98 or above for methionine, and wherein the high protein material is from a plant source comprising pea, rice or combinations thereof; inoculating the medium with a fungal culture, wherein the fungal culture comprises Lentinula edodes; and culturing the medium to produce a myceliated amino acid-supplemented high-protein food product; wherein the myceliated amino acid-supplemented high-protein food product has reduced bitterness and/or reduced metallic or mineral flavor compared to the high-protein amino acid-supplemented material that is not myceliated.

In embodiments, the present invention includes a method to prepare a myceliated amino-acid-supplemented high-protein food product, comprising the steps of: providing an aqueous medium comprising a high-protein material, wherein the aqueous medium comprises at least 50% (w/w) protein on a dry weight basis, wherein the media comprises at least 50 g/L protein, wherein the media is supplemented with at least one exogenous amino acid comprising lysine.

In this embodiment, the amount of lysine to add can include in an amount that results in an increase in lysine so that the myceliated amino acid-supplemented high-protein food product can be used in another food product, e.g., a bread, to supplement the protein in that food product such that the protein content is higher and the PDCAAS of that food product is 0.95 or greater. For example, in bread, wheat flour contains wheat gluten, however, wheat gluten has a low PDCAAS for the reason that wheat gluten is deficient in lysine. A myceliated amino acid-supplemented high-protein food product can be used in a dough for bread in an amount to provide an increased PDCAAS to the bread due to the addition of the lysine-supplemented myceliated high protein product. In this embodiment, the total protein content of a bread can be 6%, 7% or greater with a PDCAAS of about 0.9, 0.95 or more. For example, wheat gluten plus wheat flour has an approximate amount of 40 mg lysine/g protein; the high protein material prior to supplementation has about 58 mg/g protein; an amount of lysine is added to the high protein material to yield a lysine level of about 109 mg/g protein, and then subjected to the methods of the invention. Then, to yield a PDCAAS of approximately 1 for a product containing wheat flour as the main source of protein, for example, 47 g of wheat flour (13% protein), 3.5 g of wheat gluten (70% protein), and 5 g of the myceliated lysine-supplemented high protein product (78% protein) may be added together to yield a food composition (such as bread).

In this embodiment, the high protein material is from a plant source comprising pea, rice or combinations thereof; and the method further comprises inoculating the medium with a fungal culture, wherein the fungal culture comprises Lentinula edodes; and culturing the medium to produce a myceliated amino acid-supplemented high-protein food product; wherein the myceliated amino acid-supplemented high-protein food product has reduced bitterness, metallic, or mineral flavor compared to the high-protein amino acid-supplemented material that is not myceliated.

The high-protein material itself can be about 20% protein, 30% protein, 40% protein, 45% protein, 50% protein, 55% protein, 60% protein, 65% protein, 70% protein, 75% protein, 80% protein, 85% protein, 90% protein, 95% protein, or 98% protein, or at least about 20% protein, at least about 30% protein, at least about 40% protein, at least about 45% protein, at least about 50% protein, at least about 55% protein, at least about 60% protein, at least about 65% protein, at least about 70% protein, at least about 75% protein, at least about 80% protein, at least about 85% protein, at least about 90% protein, at least about 95% protein, or at least about 98% protein, all amounts by dry weight.

This invention discloses the use of concentrated media, which provides, for example, an economically viable economic process for production of an acceptably tasting and/or flavored high-protein and/or low aroma food product. In one embodiment of the invention the total media concentration is up to 150 g/L but can also be performed at lower levels, such as 5 g/L. Higher concentrations in media result in a thicker and/or more viscous media, and therefore are optionally processed by methods known in the art to avoid engineering issues during culturing or fermentation. To maximize economic benefits, a greater amount of high-protein material per L media is used. The amount is used is chosen to maximize the amount of high-protein material that is cultured, while minimizing technical difficulties in processing that may arise during culturing such as viscosity, foaming and the like. The amount to use can be determined by one of skill in the art, and will vary depending on the method of fermentation.

The amount of total protein in the aqueous media may comprise, consist of, or consist essentially of at least 20 g, 25 g, 30 g, 35 g, 40 g, 45 g, 50 g, 55 g, 60 g, 65 g, 70 g, 75 g, 80 g, 85 g, 90 g, 95 g, or 100 g, or more, of protein per 100 g dry weight, or per total all components on a dry weight basis. Alternatively, the amount of protein comprise, consist of, or consist essentially of between 20 g to 90 g, between 30 g and 80 g, between 40 g and 70 g, between 50 g and 60 g, of protein per 100 g dry weight.

In some embodiments, the total protein in aqueous media is about 45 g to about 100 g, or about 80-100 g of protein per 100 g dry weight.

In some embodiments, the aqueous media comprises between about 50 g/L and about 100 g/L, or about 80 g/L, about 85 g/L, about 90 g/L, about 95 g/L about 100 g/L, about 110 g/L, about 120 g/L, about 130 g/L, about 140 g/L, or about 150 g/L.

It can be appreciated that in calculating such percentages, the percentage of protein in the high-protein material must accounted for. For example, if the amount of high-protein material is 10 g, and the high-protein material is 80% protein, then the protein source includes 8 g protein and 2 g non-protein material. When added to 10 g of excipients to create 20 total grams dry weight, then the total is 8 g protein per 20 g total, or 40% protein, or 40 g protein per 100 g total protein. If a protein-containing excipient such as yeast extract or peptone is added to the media, the amount of protein per g total weight plus excipients will be slightly higher, taking into account the percentage of protein and the amount added of the protein-containing excipient, and performing the calculation as discussed herein, as is known in the art.

In some embodiments, the high-protein material, after preparing the aqueous media of the invention, is not completely dissolved in the aqueous media. Instead, the high-protein material may be partially dissolved, and/or partially suspended, and/or partially colloidal. However, even in the absence of complete dissolution of the high-protein material, positive changes may be affected during culturing of the high-protein material. In one embodiment, the high-protein material in the aqueous media is kept as homogenous as possible during culturing, such as by ensuring agitation and/or shaking.

In embodiments, the aqueous media further comprises, consists of, or consists essentially of materials other than the high-protein material, e.g., excipients as defined herein and/or in particular embodiments. In an embodiment, an excipient includes at least one amino acid, such as one or more BCAA, one or more SAA, or one or more lysine, which is exogenously added to the high-protein material. The natural (L-form) of the amino acids are intended for use with this invention. Commonly, when the exogenous amino acids are BCAA, the BCAA content is estimated by the sum of the amount of the amino acids valine, leucine and isoleucine. Amino acids are readily available commercially in the form of individual purified amino acids; sources that are enriched in one or more amino acids; and mixtures of amino acids. Amino acids used in the present invention are preferably food-grade.

As discussed elsewhere herein, plant sources of protein, compared to animal sources, such as milk proteins (including whey protein), tend to be deficient in the branched chain amino acids (leucine, isoleucine, and/or valine). Accordingly, in one embodiment, the protein content of a myceliated BCAA-supplemented high-protein food product can be adjusted by supplementing with a source of BCAA, by exogenously adding at least one BCAA to achieve at least 95% of the BCAA in an animal source (such as whey). Such numbers may be adjusted by the digestibility of the protein and/or food.

For example, the inventors have found that in a 65% pea protein/35% rice protein mixture, the endogenous leucine is about 8 to 9%. Therefore, an amount of exogenous one or more individual BCAA and/or total BCAA may be added to bring the total one or more individual BCAA and/or total BCAA (wt %) up to the desired level as described elsewhere herein.

Where a plant protein has an amount of SAA such as methionine that limits its PDCAAS, such as pea protein, the amount of SAA to add can be in amounts that provide at least about 95% or a PDCAAS of 0.95 or more, taking into account digestibility of the protein.

Alternatively, the total amino acid can include an amount (wt %) such as an endogenously present amount plus an amino acid exogenous supplement. The at least one amino acid exogenously added supplement can be added in an amount in an amount that results in an increase in the total wt % of the at least one amino acid in the high-protein material by at least 1% by weight (wt/wt) protein. In other words, an amount of at least one amino acid is added such that if the endogenous amount of at least one amino acid is 8%, that the final at least one amino acid amount in the composition is now 9%. The supplement can be added in an amount that results in an increase in the total wt % of at least one amino acid in the high-protein material of 1.5% or more, in an amount that results in an increase in the total wt % of the at least one amino acid in the high-protein material of about 2% or more, in an amount that results in an increase in the total wt % of the at least one amino acid in the high-protein material by at least about 2.5% or more, in an amount that results in an increase in the total wt % of at least one amino acid in the high-protein material of about 3% or more, in an amount that results in an increase in the total wt % of at least one amino acid in the high-protein material of about 3.5% or more, in an amount that results in an increase in the total wt % of at least one amino acid in the high-protein material of about 4% or more, in an amount that results in an increase in the total wt % of at least one amino acid in the high-protein material of about 4.5% or more, in an amount that results in an increase in the total wt % of at least one amino acid in the high-protein material of about 5% or more, in an amount that results in an increase in the total wt % of at least one amino acid in the high-protein material of about 5.5% or more by weight, in an amount that results in an increase in the total wt % of at least one amino acid in the high-protein material of about 6% or more, in an amount that results in an increase in the total wt % of at least one amino acid in the high-protein material of about 6.5% or more, in an amount that results in an increase in the total wt % of at least one amino acid in the high-protein material of about 7% or more, in an amount that results in an increase in the total wt % of at least one amino acid in the high-protein material of about 8% or more, in an amount that results in an increase in the total wt % of at least one amino acid in the high-protein material of about 9% or more, in an amount that results in an increase in the total wt % of at least one amino acid in the high-protein material of about 10% or more.

Alternatively, the amount of at least one amino acid in the final mixture (wt % by total protein) (total of endogenous plus exogenous amino acid) can be about 7% (or more), about 7.5% (or more), about 8% (or more), about 8.5% (or more), about 9% (or more), about 9.5% (or more), about 10% (or more), about 10.5% (or more), about 11% (or more), about 11.5% (or more), about 12% (or more), about 12.5% (or more), about 13% (or more), about 13.5% (or more), about 14% (or more), about 14.5% (or more), about 15% (or more), about 15.5% (or more), about 16% (or more), about 16.5% (or more), about 17% (or more), about 17.5% (or more), about 18% (or more), about 18.5% (or more), about 19% (or more), about 19.5% (or more), about 20% (or more), or about 20.5% (or more). Preferably, a majority of the amino-nitrogen component is present as native, non-hydrolyzed protein. In an embodiment, greater than 75% of the amino- nitrogen component is provided as native, non-hydrolyzed protein.

In an embodiment, the at least one BCAA can be 100% of one of valine, leucine, isoleucine, or any combinations of two or three of valine, leucine, or isoleucine thereof. The exact amounts and percentages of each BCAA can be determined by one of skill in the art. In one embodiment, the exogenously added BCAA comprises greater than 50% leucine. In another embodiment, the exogenously added BCAA comprises greater than 90% leucine.

As noted, products with high BCAA not only have a bitter taste but also strong, unpleasant odors, leading to low palatability. Leucine, which is considered to be the most effective of the three BCAAs at promoting muscle protein synthesis, is also the most bitter. As a result, the higher the leucine concentration, the more bitter and unpalatable the product becomes. See below Table 1. In embodiments, the exogenous BCAA is leucine.

TABLE 1

| | Taste profile | Taste thresholds (mg/mL) |
|---|---|---|
| Amino acid | (Roudot-Algaron 1996) | (Kato et al. 1989*) |
| Valine | Flat to bitter, slightly | 0.4 (bitter) |
| | sweet | |
| Leucine | Flat to bitter | 1.9 (bitter) |
| Isoleucine | Flat to bitter | 0.9 (bitter) |
| Threonine | Flat to sweet, may be | 2.6 (sweet) |
| | bitter, sour or fatty | |
| Aspartic acid | Flat, sour, slightly bitter | 0.03 (sour); 1 (umami) |
| Glutamic acid | Particular, may be meaty, | 0.05 (sour); 0.3 (umami) |
| | salt, bitter | |
| Lysine | Flat, complex, mineral | 0.5 (sweet and bitter) |
| Lysine | Bitter, complex, salt, | — |
| monohydrochloride | sweet | |

Excipients to an aqueous media also comprise any other components known in the art to potentiate and/or support fungal growth, and can include, for example, nutrients, such as proteins/peptides, amino acids as known in the art and extracts, such as malt extracts, meat broths, peptones, yeast extracts and the like; energy sources known in the art, such as carbohydrates; essential metals and minerals as known in the art, which includes, for example, calcium, magnesium, iron, trace metals, phosphates, sulphates; buffering agents as known in the art, such as phosphates, acetates, and optionally pH indicators (phenol red, for example). Excipients may include carbohydrates and/or sources of carbohydrates added to media at 5-10 g/L. It is usual to add pH indicators to such formulations.

Excipients may also optionally include peptones/proteins/peptides, as is known in the art. These are usually added as a mixture of protein hydrolysate (peptone) and meat infusion, however, as used in the art, these ingredients are typically included at levels that result in much lower levels of protein in the media than is disclosed herein. Many media have, for example, between 1% and 5% peptone content, and between 0.1 and 5% yeast extract and the like.

In one embodiment, excipients include for example, yeast extract, malt extract, maltodextrin, peptones, and salts such as diammonium phosphate and magnesium sulfate, as well as other defined and undefined components such as potato or carrot powder. In some embodiments, organic (as determined according to the specification put forth by the National Organic Program as penned by the USDA) forms of these components may be used.

In one embodiment, excipients comprise, consist of, or consist essentially of dry carrot powder, dry malt extract, diammonium phosphate, magnesium sulfate, and citric acid. In one embodiment, excipients comprise, consist of, or consist essentially of dry carrot powder between 0.1-10 g/L, dry malt extract between 0.1 and 20 g/L, diammonium phosphate between 0.1 and 10 g/L, and magnesium sulfate between 0.1 and 10 g/L. Excipients may also optionally comprise, consist of, or consist essentially of citric acid and an anti-foam component. The anti-foam component can any anti-foam component known in the art, such as a food-grade silicone anti-foam emulsion or an organic polymer anti-foam (such as a polypropylene-based polyether composition).

In another embodiment, the medium comprises, consists of or consists essentially of the high protein material as defined herein, a source of exogenous amino acid, and an anti-foam component, without any other excipients present.

The method may also comprise the optional step of sterilizing the aqueous media prior to inoculation by methods known in the art, including steam sterilization and all other known methods to allow for sterile procedure to be followed throughout the inoculation and culturing steps to enable culturing and myceliation by pure fungal strains. Alternatively, the components of the media may be separately sterilized and the media may be prepared according to sterile procedure.

The methods of the invention may further comprise inoculating the amino acid-supplemented high-protein medium with a fungal culture, wherein the fungal culture can include, comprise, consist of, or consist essentially of Lentinula edodes, Agaricus spp., Pleurotus spp., Boletus spp., or Laetiporus spp., and culturing the medium to produce a myceliated amino acid-supplemented high-protein food product.

Applicants have filed U.S. Ser. No. 16/025,365, filed Jul. 2, 2018, U.S. Ser. No. 15/488,183, filed Apr. 14, 2017, both entitled “Methods for the Production and use of Myceliated High Protein Food Compositions,” and U.S. Provisional Application No. 62/322,726, filed Apr. 14, 2016, directed to methods for the manufacture of a myceliated high protein food product, the disclosure of each of which is hereby incorporated by reference herein in its entirety.

The fungal cultures, prior to the inoculation step, may be propagated and maintained as is known in the art. In one embodiment, the fungi discussed herein can be kept on 2-3% (v/v) mango puree with 3-4% agar (m/v). Such media is typically prepared in 21.6 L handled glass jars being filled with 1.4-1.5 L media. Such a container pours for 50 -60 90 mm Petri plates. The media is first sterilized by methods known in the art, typically with an autoclave. Conventional B. stearothermophilus and thermocouple methods are used to verify sterilization parameters. Agar media can also be composed of high-protein material to sensitize the strain to the final culture. This technique may also be involved in strain selection of the organisms discussed herein. Agar media should be poured when it has cooled to the point where it can be touched by hand (˜40-50° C.).

In one embodiment, maintaining and propagating fungi for use for inoculating the high-protein material as disclosed in the present invention may be carried out as follows. For example, a propagation scheme that can be used to continuously produce material according to the methods is discussed herein. Once inoculated with master culture and subsequently colonized, Petri plate cultures can be used at any point to propagate mycelium into prepared liquid media. As such, plates can be propagated at any point during log phase or stationary phase but are encouraged to be used within three months and in another embodiment within 2 years, though if properly handled by those skilled in the art can generally be stored for as long as 10 years at 4° C. and up to 6 years at room temperature.

In some embodiments, liquid cultures used to maintain and propagate fungi for use for inoculating the high-protein material as disclosed in the present invention include undefined agricultural media with optional supplements as a motif to prepare culture for the purposes of inoculating solid-state material or larger volumes of liquid. In some embodiments, liquid media preparations are made as disclosed herein. Liquid media can be also sterilized and cooled similarly to agar media. Like agar media it can theoretically be inoculated with any fungal culture so long as it is deliberate and not contaminated with any undesirable organisms (fungi inoculated with diazotrophs may be desirable for the method of the present invention). As such, liquid media are typically inoculated with agar, liquid and other forms of culture. Bioreactors provide the ability to monitor and control aeration, foam, temperature, and pH and other parameters of the culture and as such enables shorter myceliation times and the opportunity to make more concentrated media.

In one embodiment, the fungi for use for inoculating the high-protein material as disclosed in the present invention may be prepared as a submerged liquid culture and agitated on a shaker table, or may be prepared in a shaker flask, by methods known in the art and according to media recipes disclosed in the present invention. The fungal component for use in inoculating the aqueous media of the present invention may be made by any method known in the art. In one embodiment, the fungal component may be prepared from a glycerol stock, by a simple propagation motif of Petri plate culture to 0.5-4 L Erlenmeyer shake flask to 50% glycerol stock. Petri plates can comprise agar in 10-35 g/L in addition to various media components. Conducted in sterile operation, chosen Petri plates growing anywhere from 1-˜3,652 days can be propagated into 0.5-4 L Erlenmeyer flasks (or 250 to 1,000 mL Wheaton jars, or any suitable glassware) for incubation on a shaker table or stationary incubation. The smaller the container, the faster the shaker should be. In one embodiment, the shaking is anywhere from 40-160 RPM depending on container size and, with about a 1″ swing radius.

The culturing step of the present invention may be performed by methods (such as sterile procedure) known in the art and disclosed herein and may be carried out in a fermenter, shake flask, bioreactor, or other methods. In a shake flask, in one embodiment, the agitation rate is 50 to 240 RPM, or 85 to 95 RPM, and incubated for 1 to 90 days. In another embodiment the incubation temperature is 70-90° F. In another embodiment the incubation temperature is 87 -89 ° F. Liquid- state fermentation agitation and swirling techniques as known in the art are also employed which include mechanical shearing using magnetic stir bars, stainless steel impellers, injection of sterile high-pressure air, the use of shaker tables and other methods such as lighting regimen, batch feeding or chemostatic culturing, as known in the art.

In one embodiment, culturing step is carried out in a bioreactor which is ideally constructed with a torispherical dome, cylindrical body, and spherical cap base, jacketed about the body, equipped with a magnetic drive mixer, and ports to provide access for equipment comprising DO, pH, temperature, level and conductivity meters as is known in the art. Any vessel capable of executing the methods of the present invention may be used. In another embodiment the set-up provides 0.1-5.0 ACH. Other engineering schemes known to those skilled in the art may also be used.

The reactor can be outfitted to be filled with water. The water supply system is ideally water for injection (WFI) system, with a sterilizable line between the still and the reactor, though RO or any potable water source may be used so long as the water is sterile. In one embodiment the entire media is sterilized in situ while in another embodiment concentrated media is sterilized and diluted into a vessel filled water that was filter and/or heat sterilized, or sufficiently treated so that it doesn't encourage contamination over the colonizing fungus. In another embodiment, high temperature high pressure sterilizations are fast enough to be not detrimental to the media. In one embodiment the entire media is sterilized in continuous mode by applying high temperature between 120° and 150° C. for a residence time of 1 to 15 minutes. Once prepared with a working volume of sterile media, the tank can be mildly agitated and inoculated. Either as a concentrate or whole media volume in situ, the media can be heat sterilized by steaming either the jacket, chamber or both while the media is optionally agitated. The medium may optionally be pasteurized instead.

In one embodiment, the reactor is used at a large volume, such as in 500,000-200,000 L working volume bioreactors. When preparing material at such volumes the culture must pass through a successive series of larger bioreactors, any bioreactor being inoculated at 0.5-15% of the working volume according to the parameters of the seed train. A typical process would pass a culture from master culture, to Petri plates, to flasks, to seed bioreactors to the final main bioreactor when scaling the method of the present invention. To reach large volumes, 3-4 seeds may be used. The media of the seed can be the same or different as the media in the main. In one embodiment, the fungal culture for the seed is a protein concentration as defined herein, to assist the fungal culture in adapting to high-protein media in preparation for the main fermentation. Such techniques are discussed somewhat in the examples below. In one embodiment, foaming is minimized by use of anti-foam on the order of 0.5 to 2.5 g/L of media, such as those known in the art, including insoluble oils, polydimethylsiloxanes and other silicones, certain alcohols, stearates and glycols. In one embodiment, lowering pH assists in culture growth, for example, for L. edodes pH may be adjusted by use of citric acid or by any other compound known in the art, but care must be taken to avoid a sour taste for the myceliated amino acid-supplemented high-protein product. The pH may be adjusted to between about 4.5 and 5.5, for example, to assist in growth.

In one embodiment, during the myceliation step, for example, wherein the media comprises at least 50% (w/w) protein on a dry weight basis, and/or wherein the media comprises at least 50 g/L protein, the pH does not change during processing. “pH does not change during processing” is understood to mean that the pH does not change in any significant way, taking into account variations in measured pH which are due to instrument variations and/or error. For example, the pH will stay within about plus or minus 0.3 pH units, plus or minus 0.25 pH units, plus or minus 0.2 pH units, plus or minus 0.15 pH units, or plus or minus 0.1 pH units of a starting pH of the culture during the myceliation, e.g. processing step. Minor changes in pH are also contemplated during processing, particularly in media which do not contain an exogenous buffer such as diammonium phosphate. A minor change in pH can be defined as a pH change of plus or minus 0.5 pH units or less, plus or minus 0.4 pH units or less, plus or minus 0.3 pH units or less, plus or minus 0.25 pH units or less, plus or minus 0.2 pH units or less, plus or minus 0.15 pH units or less, or plus or minus 0.1 pH units or less of a starting pH.

In one embodiment, L. edodes as the fungal component for use for inoculating an aqueous media to prepare the myceliated amino acid-supplemented high-protein food product. In this embodiment, a 1:1 mixture of pea, with amino acid supplemented to 12% by weight; the protein and rice protein are at 40% protein (8 g per 20 g total plus excipients) in the media. The increase in biomass concentration was correlated with a drop in pH. After shaking for 1 to 10 days, an aliquot (e.g. 10 to 500 mL) of the shake flask may be transferred in using sterile procedure into a sterile, prepared sealed container (such as a customized stainless steel can or appropriate conical tube), which can then adjusted with about 5-60%, sterile, room temperature (v/v) glycerol. The glycerol stocks may be sealed with a water tight seal and can be held stored at −20° C. for storage. The freezer is ideally a constant temperature freezer. Glycerol stocks stored at 4° C. may also be used. Agar cultures can be used as inoculant for the methods of the present invention, as can any culture propagation technique known in the art.

It was found that not all fungi are capable of growing in media as described herein. Fungi useful for the present invention are from the higher order Basidio- and Ascomycetes. In some embodiments, fungi effective for use in the present invention include, but are not limited to, Lentinula spp., such as L. edodes, Agaricus spp., such as A. blazei, A. bisporus, A. campestris, A. subrufescens, A. brasiliensis, or A. silvaticus; Pleurotus spp., Boletus spp., or Laetiporus spp. In one embodiment, the fungi for the invention include fungi from optionally, liquid culture of species generally known as oyster, porcini, ‘chicken of the woods’ and shiitake mushrooms. These include Pleurotus (oyster) species such as Pleurotus ostreatus, Pleurotus salmoneostramineus (Pleurotus djamor), Pleurotus eryngii, or Pleurotus citrinopileatus; Boletus (porcini) species such as Boletus edulis; Laetiporus (chicken of the woods) species such as Laetiporus sulfureus, and many others such as L. budonii, L. miniatus, L. flos-musae, L. discolor; and Lentinula (shiitake) species such as L. edodes. Also included are Lepista nuda, Hericium erinaceus, Agaricus blazeii, and combinations thereof. In one embodiment, the fungi is Lentinula edodes. Fungi may be obtained commercially, for example, from the Penn State Mushroom Culture Collection. Strains are typically received as “master culture” PDY slants in 50 mL test tubes and are stored at all, but for A. blazeii, stored at 4° C. until plated. For plating, small pieces of culture are typically transferred into sterile shake flasks (e.g. 250 mL) so as not to contaminate the flask filled with a sterilized media (liquid media recipes are discussed below). Inoculated flasks shake for approximately ten hours and aliquots of said flasks are then plated onto prepared Petri plates of a sterile agar media. One flask can be used to prepare dozens to potentially hundreds of Petri plate cultures. There are other methods of propagating master culture though the inventors find these methods as disclosed to be simple and efficient.

Determining when to end the culturing step and to harvest the myceliated amino acid-supplemented high-protein food product, which according to the present invention, to result in a myceliated amino acid-supplemented high-protein food product with acceptable taste, flavor and/or aroma profiles, can be determined in accordance with any one of a number of factors as defined herein, such as, for example, visual inspection of mycelia, microscope inspection of mycelia, pH changes, changes in dissolved oxygen content, changes in protein content, amount of biomass produced, and/or assessment of taste profile, flavor profile, or aroma profile. In one embodiment, harvest can be determined by tracking protein content during culturing and harvest before significant catabolism of protein occurs. The present inventors found that protein catabolism can initiate in bioreactors at 20 to 40 hours of culturing under conditions defined herein. In another embodiment, production of a certain amount of biomass may be the criteria used for harvest. For example, biomass may be measured by filtering, such through a filter of 10-1000 μm, and has a protein concentration between 0.1 and 25 g/L; or in one embodiment, about 0.2-0.4 g/L. In one embodiment, harvest can occur when the dissolved oxygen reaches about 10% to about 90% dissolved oxygen, or less than about 80% of the starting dissolved oxygen. Additionally, mycelial products may be measured as a proxy for mycelial growth, such as, total reducing sugars (usually a 40-95% reduction), β-glucan and/or chitin formation; harvest is indicated at 10²-10⁴ ppm. Other indicators include small molecule metabolite production depending on the strain (e.g. eritadenine on the order of 0.1-20 ppm for L. edodes or erinacine on the order of 0.1-1,000 ppm for H. erinaceus) or nitrogen utilization (monitoring through the use of any nitrogenous salts or protein, cultures may be stopped just as protein starts to get utilized or may continue to culture to enhance the presence of mycelial metabolites). In one embodiment, the total protein yield in the myceliated amino acid-supplemented high-protein food product after the culturing step is about 75% to about 95%.

“Myceliated” as used herein, means a high-protein material as defined herein having been cultured with live fungi as defined herein and achieved at least a 1%, at least 2%, at least 3%, at least 4%, at least a 5%, at least a 10%, at least a 20%, at least a 30%, at least a 40%, at least a 50%, at least a 60%, at least a 70%, at least a 80%, at least a 90%, at least a 100%, at least a 120%, at least a 140%, at least a 160%, at least a 180%, at least a 200%, at least a 250%, at least a 300%, at least a 400%, at least a 500% increase in biomass or more, to result in a myceliated high-protein food product. Alternatively, “myceliated” may refer to the distribution of a previously-grown biomass from a filamentous fungus as disclosed herein through the high-protein material but wherein growth is low and/or arrested during the culturing step (e.g., due to entry into lag phase).

Harvest includes obtaining the myceliated amino acid-supplemented high-protein food product which is the result of the myceliation step. After harvest, cultures can be processed according to a variety of methods. In one embodiment, the myceliated amino acid-supplemented high-protein food product is pasteurized or sterilized. In one embodiment, the myceliated amino acid-supplemented high-protein food product is dried according to methods as known in the art. Additionally, concentrates and isolates of the material may be prepared using variety of solvents or other processing techniques known in the art. In one embodiment the material is pasteurized or sterilized, dried and powdered by methods known in the art. Drying can be done in a desiccator, vacuum dryer, conical dryer, spray dryer, fluid bed or any method known in the art. Preferably, methods are chosen that yield a dried myeliated high-protein product (e.g., a powder) with the greatest digestibility and bioavailability. The dried myceliated amino acid-supplemented high-protein food product can be optionally blended, pestled milled or pulverized, or other methods as known in the art.

In an embodiment, the myceliated amino acid-supplemented high-protein food product has reduced bitterness and/or reduced volatile amino acid-derived fatty acid flavor compared to the high-protein amino acid-supplemented material that is not myceliated. In an embodiment, the myceliated amino acid-supplemented high-protein food product has the changed organoleptic perception as disclosed in the present invention, as determined by human sensory testing. It is to be understood that the methods of the invention only optionally include a step of determining whether the flavor and/or aroma of the myceliated amino acid-supplemented high-protein food product differs from a control material. The key determinant is, if measured by methods as disclosed herein, that the myceliated amino acid-supplemented high-protein food product is capable of providing the named differences from control materials which have not been cultured with a fungus as named herein (e.g., sham fermentation).

Sensory evaluation is a scientific discipline that analyses and measures human responses to the composition of food and drink, e.g. appearance, touch, odor, texture, temperature and taste. Measurements using people as the instruments are sometimes necessary. The food industry had the first need to develop this measurement tool as the sensory characteristics of flavor and texture were obvious attributes that cannot be measured easily by instruments. Selection of an appropriate method to determine the organoleptic qualities, e.g., flavor, of the instant invention can be determined by one of skill in the art, and includes, e.g., discrimination tests or difference tests, designed to measure the likelihood that two products are perceptibly different. Responses from the evaluators are tallied for correctness, and statistically analyzed to see if there are more correct than would be expected due to chance alone.

In the instant invention, it should be understood that there are any number of ways one of skill in the art could measure the sensory differences.

In an embodiment, the myceliated amino acid-supplemented high-protein food product, e.g., produced by methods of the invention, has reduced bitterness, reduced metallic flavor, reduced mineral flavor, and/or other undesirable flavors and/or aromas as measured by sensory testing as known in the art. Such methods include change in taste threshold, change in bitterness intensity, and the like. At least 10% or more change (e.g., reduction in) bitterness is preferred. The increase in desirable flavors and/or tastes may be rated as an increase of 1 or more out of a scale of 5 (1 being no taste, 5 being a very strong taste.) Or, a reference may be defined as 5 on a 9 point scale, with reduced bitterness or at least one flavor as 1-4 and increased bitterness or at least one flavor as 6-9.

The invention also includes wherein when the amino acid is one or more BCAA, the myceliated BCAA-supplemented high-protein food product has less perceived aroma of BCAA amino acid breakdown products (valine, leucine and isoleucine) measured by organoleptic qualities. These breakdown products include materials such as, for example, branched chain fatty acid volatiles (isobutyric, isovaleric and 2-methyl butyric acids, for example). These materials carry off flavors; isovaleric acid (foot odor, rancid cheese), isobutyric acid (acidic sour cheesy dairy buttery rancid); and 2-methyl butyric acid (acidic fruity dirty cheesy fermented). Other volatiles resulting from BCAA include dimethyl sulfide (DMS) (cooked cabbage odor), 3-methyl butanal, 2-methyl butanal (malty flavor) and methional (potato chip flavor), and others. The invention includes reduction in one or more of the named organoleptic qualities.

Additionally, the organoleptic qualities of the myceliated amino acid-supplemented high-protein food products may also be improved by processes of the current invention. For example, deflavoring can be achieved, resulting in a milder flavor and/or with the reduction of, for example, bitter and/or astringent tastes and/or beany and/or weedy and/or grassy tastes. The decrease in undesirable flavors and/or tastes as disclosed herein may be rated as a decrease of 1 or more out of a scale of 5 (1 being no taste, 5 being a very strong taste), as compared to a control where the amino acid supplementation occurs after fermentation (e.g., the exogenous amino acid is not fermented together with the high-protein material for some or all of the fermentation process.)

Culturing times and/or conditions can be adjusted to achieve the desired aroma, flavor and/or taste outcomes. As compared to the control and/or high-protein material, and/or the pasteurized, dried and powdered medium not subjected to sterilization or myceliation, the resulting myceliated amino acid-supplemented high-protein food product in some embodiments is less bitter and has a more mild, less beany aroma.

Embodiments of the present invention also include a myceliated amino acid-supplemented food product made by the methods of the invention. Embodiments also include a composition which includes a myceliated amino acid-supplemented high-protein food product, wherein the myceliated amino acid-supplemented high-protein food product is at least 50% (w/w) protein on a dry weight basis, wherein the myceliated amino acid-supplemented high protein food product is derived from a plant source, wherein the myceliated amino acid-supplemented high protein product is myceliated by a fungal culture comprising Lentinula edodes, Agaricus blazeii, Pleurotus spp., Boletus spp., or Laetiporus spp. in a media comprising at least 50 g/L protein, wherein the amino acid-supplemented high-protein food product has at least one amino acid to a level of at least 10% w/w protein and wherein the myceliated amino acid-supplemented high protein food product has reduced bitterness and/or reduced volatile BCAA-derived fatty acid aroma compared with a non-myceliated amino acid-supplemented food product.

The present invention discloses production of a food composition comprising the myceliated food product made by any of the methods of as disclosed herein, which is then used to mix with other edible components to provide the food compositions as disclosed herein. Alternatively, the invention comprises a food composition for human or animal consumption, comprising a myceliated high-protein food product, myceliated high-protein food product, wherein the myceliated high-protein food product is at least 50% (w/w) protein on a dry weight basis, wherein the myceliated high-protein product is myceliated by an aqueous fungal culture, in a media comprising at least 50 g/L protein in liquid culture; and an edible material.

Such prepared myceliated amino acid-supplemented high-protein food products can be used to create a number of food compositions, including, without limitation, using art-known methods, can be used to create a number of new food compositions, including, without limitation, reaction flavors, dairy alternative products, ready to mix beverages and beverage bases; extruded and extruded/puffed products; textured products such as meat analogs; sheeted baked goods; meat analogs and extenders; bar products and granola products; baked goods and baking mixes; granola; and soups/soup bases. The methods to prepare a food composition can include the additional, optional steps of cooking, extruding, and/or puffing the food composition according to methods known in the art to form the food compositions comprising the myceliated amino acid supplemented high protein food product of the invention. The invention includes methods to make food compositions, comprising providing a myceliated amino acid-supplemented high protein food product of the invention, providing an edible material, and mixing the myceliated amino acid-supplemented high protein food product of the invention and the edible material. The edible material can be, without limitation, a starch, a flour, a grain, a lipid, a colorant, a flavorant, an emulsifier, a sweetener, a vitamin, a mineral, a spice, a fiber, a protein powder, nutraceuticals, sterols, isoflavones, lignans, glucosamine, an herbal extract, xanthan, a gum, a hydrocolloid, a starch, a preservative, a legume product, a food particulate, and combinations thereof. A food particulate can include cereal grains, cereal flakes, crisped rice, puffed rice, oats, crisped oats, granola, wheat cereals, protein nuggets, texturized plant protein ingredients, flavored nuggets, cookie pieces, cracker pieces, pretzel pieces, crisps, soy grits, nuts, fruit pieces, corn cereals, seeds, popcorn, yogurt pieces, and combinations of any thereof.

The methods to prepare a food composition can include the additional, optional steps of cooking, extruding, and/or puffing the food composition according to methods known in the art to form the food compositions comprising the myceliated amino acid-supplemented high protein food product of the invention.

In one embodiment, the food composition can include an alternative dairy product comprising a myceliated high protein food product according to the invention. An alternative dairy product according to the invention includes, without limitation, products such as analog skimmed milk, analog whole milk, analog cream, analog fermented milk product, analog cheese, analog yogurt, analog butter, analog dairy spread, analog butter milk, analog acidified milk drink, analog sour cream, analog ice cream, analog flavored milk drink, or an analog dessert product based on milk components such as custard. Methods for producing alternative dairy products using alternative proteins, such as plant-based proteins as disclosed herein including nuts (almond, cashew), seeds (hemp), legumes (pea), rice, and soy are known in the art. These known methods for producing alternative dairy products using a plant-based protein can be adapted to use with a myceliated high protein food product using art-known techniques.

An alternative dairy product according to the invention may additionally comprise non-milk components, such as oil, protein, carbohydrates, and mixtures thereof. Dairy products may also comprise further additives such as enzymes, flavoring agents, microbial cultures, salts, thickeners, sweeteners, sugars, acids, fruit, fruit juices, any other component known in the art as a component of, or additive to a dairy product, and mixtures thereof

Milks. A myceliated high protein food product according to the invention may be used to create a myceliated high protein-based “milk” beverage produced by using the myceliated high protein food product, optionally, by combining the product as a powder with oils and carbohydrates to form an emulsion, preferably a stable emulsion. Methods for creating vegan protein milks using soybeans as the protein source are known in the art and protein source may simply be substituted with myceliated high protein food product protein. As a non-limiting example, a typical unsweetened “milk” drink includes, per 243 ml serving, a total of 4 g carbohydrates which can include 1 g of sugar, 4 g of fat or oil from any source, and myceliated high protein food product solids sufficient to provide between about 1-10 g of protein, the drink being in the form of a stable emulsion of oil, water, and protein. The ratio of myceliated high protein food product to the other ingredients can be varied depending on the desired protein level of the drink and the desired organoleptic properties. Typically, the amount will vary between about 0.1-10% g protein per mL beverage, or about 0.5 to 7%, 1% to 5% or about 1.1-1.3%. The resulting slurry or purée may optionally be brought to a boil in order to e.g., improve its flavor, and to sterilize the product. Heating at or near the boiling point is continued for a period of time, 15-20 minutes, followed by optional removal of insoluble residues by e.g., filtration.

In an example, the milk-based beverage can include 2.7 g myceliated high protein food product per 240 mL serv, 4 g carbohydrates which can include 1 g of sugar, 4 g of fat or oil from any source.

Yogurt: myceliated high protein food product may be used to create a myceliated high protein food product -based “yogurt” beverage produced by using myceliated high protein food product, optionally, by combining myceliated high protein food product with the other ingredients in powder form. Methods for creating vegan yogurt using soybeans as the protein source are known in the art and protein source may simply be substituted with myceliated high protein food product protein, for example, to create the yogurts of the invention. For example, myceliated high protein food product can be used as 1.1% to about 7% (e.g., 10.7 g) myceliated high protein food product solids sufficient to provide between about 1-10 g of protein per serving. Other ingredients in the yogurt can include, without limitation, as known in the art, nut milks (almond, cashew, for example), fats or oils (such as coconut cream, coconut oils), sugar, and thickening or gelling agents including, without limitation, agents such as locust bean gums, pectin, and the like. The composition, in some embodiments, will contain no less than 2.5% fat from a plant source, such as, without limitation, almond, cashew, and/or coconut and no less than 3.5% protein. Frozen yogurts will have similar compositions.

In an example, the yogurt can include 68.7% by weight of an almond milk, 21.9% of a cashew milk, 3.35% of coconut cream, 4.75% of myceliated high protein food product, 1.18% of dextrose, 0.05% of locust bean gum, 0.05% of pectin, and 0.02% of live bacterial cultures customary for yogurt preparations, such as mixtures of lactic acid producing bacteria Lactobacillus bulgaricus and Streptococcus thermophilus. For a frozen dessert, example amounts of myceliated high protein food product can include about 4 g myceliated high protein food product per 79 g serving (cashew) or 6.67 g myceliated high protein food product per 85 g serving.

Ice Cream: myceliated high protein food product may be used to create a myceliated high protein food product-based “ice cream” beverage produced by using myceliated high protein food product, optionally, by combining myceliated high protein food product with the other ingredients in powdered form. Methods for creating vegan ice cream using soybeans as the protein source are known in the art and protein source may simply be substituted with myceliated high protein food product protein, for example, to create the ice creams of the invention. For example, myceliated high protein food product can be used as 1.1% to 7% (10.7 g) myceliated high protein food product solids sufficient to provide between about 1-10 g of protein per serving. Other ingredients in the ice cream can include, without limitation, as known in the art, creams, fats or oils (such as coconut cream, coconut oil), sugar, and thickening or gelling agents including, without limitation, agents such as locust bean gum, pectin, emulsifiers such as lecithin, and the like. The composition, in some embodiments, will contain no less than 10% fat from a plant source, such as, without limitation, almond, cashew, and/or coconut and no less than 3.5% protein and no less than 35% total solids.

In an example, the ice cream can include 45.5% by weight of water, 32% of coconut cream (34.7% fat), 4.5% of myceliated high protein food product 17% of sugar, 0.6% of a gum, 0.2% of lecithin, 0.2% of sea salt.

The present invention can also include beverages and beverage bases comprising a myceliated high protein food product according to the invention which can be used as non-dairy-based meal replacement beverages. A myceliated high protein food product according to the invention may be used to prepare a meal replacement beverage that is optionally non-dairy-based. Methods for creating vegan meal replacement beverages using soybeans as the protein source are known in the art and protein source may simply be substituted with myceliated high protein food product protein of the invention, for example. For example, a typical meal replacement drink would include, per 243 ml serving, a total of 4 g carbohydrates which can include 1 g of sugar, 4 g of fat or oil from any source, and myceliated high protein food product solids sufficient to provide between about 2-30 g of protein. The ratio of myceliated high protein food product can be varied depending on the desired protein level of the drink and the desired organoleptic properties. Typically, the amount will vary between about 0.1-15% g protein per mL beverage, or about 0.5 to 7%, 1% to 5% or about 1.1-1.3%. The resulting slurry or purée may optionally be brought to a boil in order to e.g., improve its flavor, and to sterilize the product. Heating at or near the boiling point is continued for a period of time, 15-20 minutes, followed by optional removal of insoluble residues by e.g., filtration. A ready to mix beverage powder can include 32.7 g of myceliated high protein food product per 35 g serving. Examples of products include protein shakes and smoothies, and dietary and nutritional beverages including meal replacement beverages and smoothies.

In an exemplary formulation, a non-dairy-based meal replacement beverage can have about 20 g of the myceliated high protein food product per 243 g serving.

The present invention can also include extruded and/or puffed products and/or cooked products comprising a myceliated high protein food product of the invention. Extruded and/or puffed ready-to-eat breakfast cereals and snacks such as crisps or scoops and pasta noodles are known in the art. Extrusion processes are well known in the art and appropriate techniques can be determined by one of skill. “Extrusion” is a process used to create objects of a fixed cross-sectional profile. A material is pushed or pulled through a die of the desired cross-section. The two main advantages of this process over other manufacturing processes are its ability to create very complex cross-sections, and to prepare products that are brittle, because the material only encounters compressive and shear stresses. High-moisture extrusion is known as wet extrusion. Extruders typically comprise an extruder barrel within which rotates a close-fitting screw. The screw is made up of screw elements, some of which are helical screw threads to move material through the extruder barrel. Material is introduced into the extruder barrel toward one end, moved along the extruder barrel by the action of the screw and is forced out of the extruder barrel through a nozzle or die at the other end. The rotating screw mixes and works the material in the barrel and compresses it to force it through the die or nozzle. The degree of mixing and work to which the material is subjected, the speed of movement of the material through the extruder barrel and thus the residence time in the extruder barrel and the pressure developed in the extruder barrel can be controlled by the pitch of the screw thread elements, the speed of rotation of the screw and the rate of introduction of material into the extruder barrel. The extruder barrel comprises multiple extruder barrel sections which are joined end to end. Multiple extruder barrel sections are required to carry out different processes involved in extrusion such as conveying, kneading, mixing, devolatilizing, metering and the like. Each extruder barrel section comprises a liner which is press fit into an extruder barrel casing, and heating and cooling elements are provided to regulate temperature of extruder barrel section within permissible range. The total length of an extrusion process can be defined by its modular extrusion barrel length. An extruder barrel is described by its unit of diameter. A “cooling die” is cooling the extruded product to a desired temperature.

For example, cold extrusion is used to gently mix and shape dough, without direct heating or cooking within the extruder. In food processing, it is used mainly for producing pasta and dough. These products can then be subsequently processed: dried, baked, vacuum-packed, frozen, etc.

Hot extrusion is used to thermomechanically transform raw materials in short time and high temperature conditions under pressure. In food processing, it is used mainly to cook biopolymer-based raw materials to produce textured food and feed products, such as ready-to-eat breakfast cereals, snacks (savory and sweet), pet foods, feed pellets, etc. The extruding can include, for example, melting and/or plasticization of the ingredients, gelatinization of starch and denaturation of proteins. The heat can be applied either through, for example, steam injection, external heating of the barrel, or mechanical energy. The material can be pumped, shaped and expanded, which forms the porous and fibrous texture, and partially dehydrates the product. The shape and size of the final product can be varied by using different die configurations. Extruders can be used to make products with little expansion (such as pasta), moderate expansion (shaped breakfast cereal, meat substitutes, breading substitutes, modified starches, pet foods (soft, moist and dry)), or a great deal of expansion (puffed snacks, puffed curls and balls, etc.).

The myceliated high protein food product of the invention may be used in formulating foods made by extrusion and/or puffing and/or cooking processes, such as ready to eat breakfast cereals and snack foods. These materials are formulated primarily with cereal grains and may contain flours from one or more cereal grains. The cereal grains utilized, such as corn, wheat, rice, barley, and the like, have a high starch content but relatively little protein. A cereal having more protein content, therefore, is desirable from a nutritional standpoint. The composition of the present invention contain flour from at least one cereal grain, preferably selected from corn and/or rice, or alternatively, wheat, rye, oats, barley, and mixtures thereof. The cereal grains used in the present invention are commercially available, and may be whole grain cereals, but more preferably are processed from crops according to conventional processes for forming refined cereal grains. The term “refined cereal grain” as used herein also includes derivatives of cereal grains such as starches, modified starches, flours, other derivatives of cereal grains commonly used in the art to form cereals, and any combination of such materials with other cereal grains. A refined corn for example, is formed from U.S. No. 1 or No. 2 yellow dent corn by dry milling the corn to separate the endosperm from the germ and bran, and forming corn meal, corn grits, or corn flour from the endosperm. Refined wheat grain may be formed according to commercial milling practices from hard or soft wheat varieties, red or white wheat varieties, and may be a wheat flour containing little or no wheat bran, a wheat bran, or a milled wheat product containing flour, bran, and germ (whole wheat flour). Refined rye is preferably a rye flour which is formed according to commercial milling practices. Refined rice may be heads, second heads, or brewers rice which is formed by conventional practices for dehulling rough rice and pearling the dehulled rice, and preferably rough grinding the pearled and dehulled rice into a rice flour. Oats are refined by conventional practices into oat meal by dehulling and cleaning the oats to form oat groats and milling the oat groats to form oat meal or oat flour. The refined oats may also be defatted. Barley is refined according to conventional practices into barley flakes or barley grits by dehulling and cleaning the barley to form clean barley which is pearled and flaked or ground to form the barley flakes or barley grits.

The breakfast cereal and snack materials can obtain the desired flake structure by a process known as puffing. Basically, a cereal is puffed by causing trapped moisture in the flake to change very rapidly from the liquid state to the vapor phase. Rapid heating or a rapid decrease in pressure are the methods commonly used throughout the industry. Gun puffing is an example of the principle of a rapid decrease in pressure. In this process the cereal flakes are first heated under high pressure and then the pressure is rapidly released to achieve the puffing effect. The process disclosed in U.S. Pat. No. 3,253,533 is an example of a rapid heating puffing method.

To achieve the optimum puffing, care must be taken in regard to the initial moisture content of the unpuffed flake. The specific moisture content that is best is dependent on the particular type of puffing process being utilized. For instance, a moisture content of 12 to 14 percent is best for gun puffing while to 12 percent is best for puffing by a process that rapidly heats the flake. The optimum moisture content for any one puffing technique can routinely be determined experimentally. Additional processing steps can be utilized if it is so desired. For instance a toasting operation can be used after the puffing step if it is desired to change the color of the flake to a more desired rich golden brown. Frequently, a slight toasting step also brings out a pleasant toasted flavor note.

The food product produced using the methods described herein can be in the form of crunchy curls, puffs, chips, crisps, crackers, wafers, flat breads, biscuits, crisp breads, protein inclusions, cones, cookies, flaked products, fortune cookies, etc. The food product can also be in the form of pasta, such as dry pasta or a ready-to-eat pasta. The product can be used as or in a snack food, cereal, or can be used as an ingredient in other foods such as a nutritional bar, breakfast bar, breakfast cereal, or candy. In a pasta, the myceliated high protein food product may be, in a non-limiting example, be used in levels of about 10 g per 58 g serving (17%).

Baked goods.

Food compositions of the invention also include bakery products and baking mixes comprising myceliated high protein food products according to the invention according to known methods. The term “bakery product” includes, but is not limited to leavened or unleavened, traditionally flour-based products such as white pan and whole wheat breads (including sponge and dough bread), cakes, pretzels, muffins, donuts, brownies, cookies, pancakes, biscuits, rolls, crackers, pie crusts, pizza crusts, hamburger buns, pita bread, and tortillas.

In accordance with embodiments of the invention, leavening agents may be included in dough to produce products, which require a rising, such as crackers and breads. Exemplary leavening agents include yeast, baking powder, eggs, and other commercially available leavening agents. Preferably, leavening agents will comprise less than about 5%, by weight, of the dry ingredients.

Dough in accordance with embodiments of the invention may also include gums such as xanthum, guar, agar, and other commercially available hydrocolloids typically used for dough binding and conditioning. Additionally, food grade oils can be used to improve sheeting, texture, browning, and taste. Exemplary oils include soybean oil, canola oil, corn oil, and other commercially available oils. Lecithin may also be added to improve emulsification, water binding, and dough release.

In an embodiment, the amount of myceliated high protein food product in the bakery products or bakery mixes is in the range of at least 2 to 7 grams per 50 gram serving, or 5 or 6 grams per serving. A method of producing a food composition of the invention includes forming a cohesive dough by measuring and mixing the dry ingredients using standard mixing equipment.

Bread, rolls, bagels, and English muffins according to the invention may have between about 4.8% to about 7% (2.7 g) myceliated high protein food product of the invention per 40 g serving (adding 2 g protein for high protein bread formulation.)

Bars and granolas

The present invention also includes food compositions such as granola cereals, and bar products, including such as granola bars, nutrition bars, energy bars, sheet and cut bars, extruded bars, baked bars, and combinations thereof.

The baked food compositions and bar compositions are generally formed dependent on the desired end product. The baked food compositions and bar compositions are produced according to standard industry recipes, substituting in a myceliated high-protein food product of the present invention for at least some of the called-for protein ingredients.

For the extruded compositions, protein fortification may be accomplished by supplementing the bar with edible proteins from at least one high protein content source, as known in the art, and including the myceliated food product of the present invention, either alone or as combinations with other proteins Based upon the weight of the extrudate, or core, a suitable amount of the at least one high protein content source is about 20% to about 30% by weight. The protein content should be at least about 15% by weight, based upon the weight of the final product.

In the present invention, a liquid sweet ingredient, such as corn syrup, preferably high fructose corn syrup, is used as a carbohydrate content source. In one embodiment, the liquid sweet ingredient provides a moist chewy texture to the bar, provides sweetness, and serves to distribute the dry ingredients. The liquid sweet ingredient can include, without limitation, corn syrup, high fructose corn syrup, honey, tapioca syrup, among others as known in the art. Additionally, the liquid sweet ingredient, in combination with other binders known in the art, can be useful to bind the other ingredients, such as the protein content and other carbohydrate content sources together. Suitable amounts of the liquid sweet ingredient are about 25% to about 30% by weight, based upon the weight of the extrudate. At least one other carbohydrate content source may be optionally included in the bar of the present invention. Exemplary of suitable carbohydrate content sources for providing a caloric distribution within the above ranges are sugars, such as fructose granules, brown sugar, sucrose, and mixtures thereof, and cereal grains such as rice, oats, corn, and mixtures thereof. Preferably, the snack contains at least one sugar and at least one carbohydrate. Based upon the weight of the core, suitable amounts of these ingredients are about 3% to about 10% by weight of at least one sugar, and about 12% to about 18% by weight of at least one cereal grain. The bar also optionally comprises a fat. Suitable sources of fats include those known in the art to be suitable for bar-type products and include milk, chocolate, and coconut oils, creams, and butters; nut butters such as peanut butter, and an oil such as vegetable oil. Also, a liquid wetting agent may be present in the composition, to facilitate mixing and binding of the dry ingredients to enhance moistness and chewiness of the snack. Exemplary of such wetting agents are molasses, honey, and vegetable oils, and mixtures thereof. A suitable amount of the at least one wetting agent is about 2% to 5% by weight. Suitable amounts of the flavoring ingredients range up to about 3% by weight. Also it is known in the art that carbohydrate content sources, useful in the present invention, may also be substantial sources of proteins and/or fats. For example, peanut flour, oats, and wheat germ each provide substantial amounts of proteins, carbohydrates, and fats. Dietary fiber can be included in the bar. Suitable amounts are about 3% to about 8%, preferably about 5% by weight fiber, based upon the weight of the final product. Suitable sources of dietary fiber are rolled oats and brans. The bar may be topped with conventional toppings, such as granola, crushed nuts, and the like, to enhance flavor and visual appeal. Suitable topping amounts are about 2% to 3% by weight of the final product.

In one embodiment, the nutritional snacks of the present invention are made by first mixing the liquid ingredients and the optional wetting agent. Next, the minor dry components are added to the mixed liquids. The minor dry components include ingredients such as, for example, minerals and vitamins, preferably premixed, and optional salt. The major dry ingredients can then admixed with the mixed liquids and minor dry ingredients to form a substantially homogeneous mixture. The major dry ingredients include e.g., sugars and cereal grains. The major dry ingredients also include the high protein content sources including the myceliated high protein food product of the invention. The flavoring ingredients, such as cocoa or coconut, can be added with the minor dry ingredients or with the major dry ingredients. All mixing can be in the same mixer or blender. Suitable mixing and blending equipment include conventional vertical and horizontal type mixers and blenders.

The mixed ingredients can be transferred via conveyor belts and hoppers, for example, to a conventional bar extruder, having opposing rollers which force the mixture through a die to form the extrudate or core. The extrusion is performed at about room temperature. No cooking or heating during or after extrusion is necessary nor desirable. The preferred extruded shape is a rectangular bar, but other shaped bars, known in the snack bar art, such as cylindrical, and semicylindrical shaped bars can be made using appropriate extruder dies.

In accordance with the present invention, the granola cereals and bar products, the dry ingredients can include a food particulate. A food particulate may include, without limitation, any edible food particulate. Such particulates can include flours, meals, cereal grains, cereal flakes, crisped rice, puffed rice, oats, crisped oats, granola, wheat cereals, protein nuggets, textured soy flour, textured soy protein concentrate, texturized protein ingredients such as those disclosed herein, flavored nuggets, cookie pieces, cracker pieces, pretzel pieces, crisps, soy grits, nuts, fruit pieces, vegetable pieces, corn cereals, seeds, popcorn, yogurt pieces, and combinations of any thereof.

For example, for grain-based bars, an appropriate amount of myceliated high protein food product includes from between about 20% to about 33.3% (20 g) myceliated high protein food product per 60 g serving (for example, 15 g protein in a high protein bar). Where the bar contains a fruit and/or vegetable, an appropriate amount of myceliated high protein food product includes can include about 20% (8 g) myceliated high protein food product per 45 g serving (adding 6 g to a total of 8 g in a high protein type bar.)

After extrusion, the product may be dried. The final product will have a moisture content of from about 1% to about 8%, depending on the desired characteristics of the finished product.

In one embodiment, an extruded nutritional protein bars may include 21.33 g/60 g of myceliated high protein food product of the present invention, with the balance including carbohydrate, nuts, oils, with proportions determined by conventional processes known in the art.

Food compositions of the present invention also include smoothies and smoothie bases, and juices, and soups and soup bases, fats and oils. For example, salad dressings can include about 8 g myceliated high protein food product of the invention per 30 g serving; a fruit juice, fruit flavored drink, fruit nectar may include about 1% by weight of myceliated high protein product of the invention. A vegetable juice such as a tomato juice can include between about 2.5% to about 20% (8 g) myceliated high protein food product of the invention per 240 mL serving. A smoothie may contain between about 3.5% to 20% by weight or between 9 and 20 g of myceliated high protein product of the invention, for example about 40 g per 450 mL serving.

For a soup or soup base (mix), prepared soups, dry soup mixes, and condensed soups, a myceliated high protein food product may be added in an amount of between 0.96%-˜3.3% by weight (8 g) per 242 g serving. For a confectionary, such as a chocolate dessert (peanut butter cup), a myceliated food product of the invention may include about 2.67 g per 40 g serving.

### Reaction Flavors

The Maillard reaction is a chemical reaction between amino acids and reducing sugars that gives browned food its distinctive flavor. Seared steaks, pan-fried dumplings, cookies and other kinds of biscuits, breads, toasted marshmallows, and many other foods undergo this reaction. The reaction is a form of non-enzymatic browning which typically proceeds rapidly from around 140 to 165° C. (280 to 330° F.). Many recipes call for an oven temperature high enough to ensure that a Maillard reaction occurs. At higher temperatures, caramelization and subsequently pyrolysis become more pronounced. In a Maillard reaction, the reactive carbonyl group of the sugar reacts with the nucleophilic amino group of the amino acid and forms a complex mixture of poorly characterized molecules responsible for a range of aromas and flavors. This process is accelerated in an alkaline environment (e.g., lye applied to darken pretzels; see lye roll), as the amino groups (RNH₃⁺→RNH₂) are deprotonated, hence have an increased nucleophilicity.

In one embodiment, the present invention includes a method to prepare a reaction flavor composition. In this embodiment, the edible material comprises providing at least one reaction flavor component capable of facilitating Maillard and/or Strecker reactions. In another step, the method includes mixing the myceliated high protein food product and the reaction flavor component. In yet another step, the method includes processing the mixture to form the reaction flavor composition. The Maillard reaction is a chemical reaction between amino acids and reducing sugars that gives browned food its distinctive flavor. Seared steaks, pan-fried dumplings, cookies and other kinds of biscuits, breads, toasted marshmallows, and many other foods undergo this reaction. The reaction is a form of non-enzymatic browning which typically proceeds rapidly from around 140 to 165° C. (280 to 330° F.). Other methods known in the art include microwave processing, such as, for example, as disclosed in WO 2018/083224, published 11 May 2018, which is incorporated herein by reference in its entirety.

In one embodiment of the invention, the precursor material for the reaction flavor is a myceliated amino acid supplemented high-protein food product as disclosed herein and as made by processes disclosed herein. To the myceliated high protein food product as disclosed herein, a number of precursor compounds can be added, as known in the art, which can be varied in a manner known by a skilled flavorist, depending on the particular reaction flavor that is desired to create. Precursor compounds that can be added to the myceliated high protein food product include amino acids/amine sources, reducing sugars, as well as lipids or fats, spices and additional protein sources, such as hydrolyzed vegetable proteins (HVPs) or yeast autolysates.

In an embodiment, the present invention also includes a method to prepare a textured plant-based protein product useful for products such as meat-structured meat analogs or meat extenders. This textured plant-based meat analog or meat extender, in one embodiment, has texture associated with meat. The method optionally provides a “meat structured protein product” which can be made from the “texturized protein product” as disclosed herein. Integral to a meat structured protein product is a texturized protein product which refers to a product comprising protein fiber networks and/or aligned protein fibers that produce meat-like textures. It can be obtained from a dough after application of e.g., mechanical energy (e.g., spinning, agitating, shaking, shearing, pressure, turbulence, impingement, confluence, beating, friction, wave), radiation energy (e.g., microwave, electromagnetic), thermal energy (e.g., heating, steam texturizing), enzymatic activity (e.g., transglutaminase activity), chemical reagents (e.g., pH adjusting agents, kosmotropic salts, chaotropic salts, gypsum, surfactants, emulsifiers, fatty acids, amino acids), other methods that lead to protein denaturation and protein fiber alignment, or combinations of these methods, followed by fixation of the fibrous and/or aligned structure (e.g., by rapid temperature and/or pressure change, rapid dehydration, chemical fixation, redox), and optional post-processing after the fibrous and/or aligned structure is generated and fixed (e.g., hydrating, marinating, drying, coloring). Methods for determining the degree of protein fiber network formation and/or protein fiber alignment are known in the art and include visual determination based upon photographs and micrographic images, as exemplified in U.S. Utility application Ser. No. 14/687,803 filed Apr. 15, 2015. In some embodiments, at least about 55%, at least about 65%, at least about 75%, at least about 85%, or at least about 95% of the protein fibers are substantially aligned. Protein fiber networks and/or protein fiber alignments may impart cohesion and firmness whereas open spaces in the protein fiber networks and/or protein fiber alignments may tenderize the meat structured protein products and provide pockets for capturing water, carbohydrates, salts, lipids, flavorings, and other materials that are slowly released during chewing to lubricate the shearing process and to impart other meat-like sensory characteristics.

In one embodiment, the method to make a textured plant-based protein product includes the step of providing a myceliated amino-acid supplemented high protein product according to the present invention. Further, the myceliated amino-acid supplemented high-protein food product has reduced undesirable flavor and/or reduced undesirable aroma compared with a non-myceliated food product, as described herein. The method may include providing an additional material, such as an additional high-protein material, fiber, starch or other materials; and mixing the myceliated amino-acid supplemented high-protein food product and the additional material to form a mixture; optionally preconditioning the mixture, e.g., by adding steam and/or water to the mixture, and extruding the mixture under heat and pressure under conditions capable of forming a textured plant-based protein product useful for products such as meat-structured meat analogs or meat extenders that contain no animal products. The method to prepare a textured plant-based protein product may also include the step of providing an optional carbohydrate component. The carbohydrate ingredients are typically classified as a starch, a flour, or an edible fiber and the carbohydrate component may comprise one or more types of starch, flour, edible fiber, and combinations thereof.

Starch is the primary carbohydrate source used to help the formation of the product texture in textured plant-based protein products. Typical starches used include rice starch, wheat starch, oat starch, corn starch, potato starch, cassava starch, and tapioca starch, although starch from any source is contemplated. Overall, the swelling ability of starch, solubility, amount of amylose leaching out during gelatinization, and the ability to produce a viscous paste, have an effect on the textured plant-based protein product. Chemical alterations occur due to structural changes of the macromolecules in the feed blend, such as starch gelatinization and protein denaturation, as well as incorporation of water into the molecular matrix, all of which convert the raw feed particles into a viscoelastic dough under a pressurized environment. Physical changes, on the other hand, are related to product expansion due to a drastic pressure drop and water evaporation during die exit. In one embodiment, the textured plant-based protein product includes an edible fiber. Examples of suitable edible fiber include but are not limited to bamboo fiber, barley bran, carrot fiber, citrus fiber, corn bran, soluble dietary fiber, insoluble dietary fiber, oat bran, pea fiber, soy fiber, soy polysaccharide, wheat bran, wood pulp cellulose, modified cellulose, seed husks, oat hulls, citrus fiber, carrot fiber, corn bran, soy polysaccharide, barley bran, and rice bran. The fiber may be present in the dry pre-mix from about 0.1% to about 10% by weight.

Seasonings, vitamins, minerals, and/or preservatives can be added before or after the extruding and/or cooking and/or puffing steps. Edible oils and/or fats can also be added; or emulsifiers, sweeteners, and combinations thereof.

Extrusion is a technology to produce texturized proteins, a unique product which can be produced from a wide range of raw ingredient specifications, while controlling the functional properties such as density, rate and time of rehydration, shape, product appearance and mouthfeel.

The general procedure is as follows, as is known in the art. The flour mix is prepared and typically the dry ingredients are blended together in the premixture stage. In the optional preconditioning step (in a section of an extruder device known as preconditioner) the steam and water are usually added at this stage to wet/moisten and warm the flour mix. In the extruder, the majority of the work happens. Generally, the starch and protein are plasticized using heat, pressure and/or mechanical shear, then realigned and expanded as the mixture exits the extruder. The material coming from the extruder moisture ranges from 25% to 30%. Optionally, this extruded material can be dried to about 3% - 5% moisture or less in the dryer portion. Cooling then optionally occurs to lower the temperature of the dried product to ambient conditions followed by an optional packaging step.

The following examples further illustrate the invention but, of course, should not be construed as in any way limiting its scope.

### EXAMPLES

### Example 1

Eighteen (18) 1 L baffled DeLong Erlenmeyer flasks were filled with 0.400 L of a medium consisting of 25 g/L organic pea protein concentrate (labeled as 80% protein), 25 g/L organic rice protein concentrate (labeled as 80% protein), 4 g/L organic dry malt extract, 2 g/L diammonium phosphate, 1 g/L organic carrot powder and 0.4 g/L magnesium sulfate heptahydrate in RO water. The flasks were covered with a stainless steel cap and sterilized in an autoclave on a liquid cycle that held the flasks at 120-121° C. for 90 minutes. The flasks were carefully transferred to a clean HEPA laminar flowhood where they cooled for 18 hours. Sixteen (16) flasks were subsequently inoculated with 2 cm² pieces of mature Petri plate cultures of P. ostreatus, P. eryngii, L. nuda, H. erinaceus, L. edodes, A. blazeii, L. sulfureus and B. edulis, each strain done in duplicate from the same plate. All 18 flasks were placed on a shaker table at 150 rpm with a swing radius of 1″ at room temperature. The Oyster (P. ostreatus), Blewit (Lepista nuda) and Lion's Mane (H. erinaceus) cultures were all deemed complete at 72 hours by way of visible and microscopic inspection (mycelial balls were clearly visible in the culture, and the isolation of these balls revealed dense hyphal networks under a light microscope). The other samples, but for the Porcini (Boletus edulis) which did not grow well, were harvested at 7 days. All samples showed reduced pea and reduced rice aroma and flavor, as well as less “beany” type aromas/flavors. The Oysters had a specifically intense savory taste and back-end mushroom flavor. The Blewit was similar but not quite as savory. The Lion's Mane sample had a distinct ‘popcorn’ aroma. The 3, 7 day old samples were nearly considered tasteless but for the Chicken of the Woods (Laetiporus sulphureus) sample product which had a nice meaty aroma and had no pea or rice aroma/flavor. The control sample smelled and tasted like a combination of pea and rice protein and was not considered desirable. The final protein content of the resulting cultures was between 50-60% and the yields were between 80-90% after desiccation and pestling.

### Example 2

Three (3) 4 L Erlenmeyer flasks were filled with 1.5 L of a medium consisting of 5 g/L pea protein concentrate (labeled as 80% protein), 5 g/L rice protein concentrate (labeled as 80% protein), 3 g/L malt extract and 1 g/L carrot powder. The flasks were wrapped with a sterilizable biowrap which was wrapped with autoclave tape 5-6 times (the taped biowrap should be easily taken off and put back on the flask without losing shape) and sterilized in an autoclave that held the flasks at 120-121° C. for 90 minutes. The flasks were carefully transferred to a clean HEPA laminar flowhood where they cooled for 18 hours. Each flask was subsequently inoculated with 2 cm² pieces of 60 day old P1 Petri plate cultures of L. edodes and placed on a shaker table at 120 rpm with a 1″ swing radius at 26° C. After 7-15 days, the inventors noticed, by using a pH probe on 20 mL culture aliquots, that the pH of every culture had dropped nearly 2 points since inoculation. L. edodes is known to produce various organic acids on or close to the order of g/L and the expression of these acids are likely what dropped the pH in these cultures. A microscope check was done to ensure the presence of mycelium and the culture was plated on LB media to ascertain the extent of any bacterial contamination. While this culture could have been used as a food product with further processing (pasteurization and optionally drying), the inventors typically use such cultures as inoculant for bioreactor cultures of media prepared as disclosed according to the methods of the present invention.

### Example 3

A 7 L bioreactor was filled with 4.5 L of a medium consisting of 5 g/L pea protein concentrate (labeled as 80% protein), 5 g/L rice protein concentrate (labeled as 80% protein), 3 g/L malt extract and 1 g/L carrot powder. Any open port on the bioreactor was wrapped with tinfoil and sterilized in an autoclave that held the bioreactor at 120-121° C. for 2 hours. The bioreactor was carefully transferred to a clean bench in a cleanroom, setup and cooled for 18 hours. The bioreactor was inoculated with 280 mL of inoculant from a 12 day old flask as prepared in Example 2. The bioreactor had an air supply of 3.37 L/min (0.75 VVM) and held at 26° C. A kick-in/kick-out anti-foam system was setup and it was estimated that ˜1.5 g/L anti-foam was added during the process. At ˜3-4 days the inventors noticed that the pH of the culture had dropped 1.5 points since inoculation, similar to what was observed in the flask culture. A microscope check was done to ensure the presence of mycelium (mycelial pellets were visible by the naked eye) and the culture was plated on LB media to ascertain the extent of any bacterial contamination and none was observed. While this culture could have been used as a food product with further processing (pasteurization and optionally drying), the inventors typically use such cultures as inoculant for bioreactor cultures of media prepared as disclosed according to the methods of the present invention.

### Example 4

A 250 L bioreactor was filled with 150 L of a medium consisting of 45 g/L pea protein concentrate (labeled as 80% protein), 45 g/L rice protein concentrate (labeled as 80% protein), 1 g/L carrot powder, 1.8 g/L diammonium phosphate, 0.7 g/L magnesium sulfate heptahydrate, 1 g/L anti-foam and 1.5 g/L citric acid and sterilized in place by methods known in the art, being held at 120-121 ° C. for 100 minutes. The bioreactor was inoculated with 5 L of inoculant from two bioreactors as prepared in Example 3. The bioreactor had an air supply of 30 L/min (0.2 VVM) and held at 26° C. The culture was harvested in 4 days upon successful visible (mycelial pellets) and microscope checks. The pH of the culture did not change during processing but the DO dropped by 25%. The culture was plated on LB media to ascertain the extent of any bacterial contamination and none was observed. The culture was then pasteurized at 82° C. for 30 minutes with a ramp up time of 30 minutes and a cool down time of 45 minutes to 17° C. The culture was finally spray dried and tasted. The final product was noted to have a mild aroma with no perceptible taste at concentrations up to 10%. The product was ˜75% protein on a dry weight basis.

### Example 5

A 250 L bioreactor was filled with 150 L of a medium consisting of 45 g/L pea protein concentrate (labeled as 80% protein), 45 g/L rice protein concentrate (labeled as 80% protein), 1 g/L carrot powder, 1.8 g/L diammonium phosphate, 0.7 g/L magnesium sulfate heptahydrate, 1 g/L anti-foam and 1.5 g/L citric acid and sterilized in place by methods known in the art, being held at 120-121° C. for 100 minutes. The bioreactor was inoculated with 5 L of inoculant from two bioreactors as prepared in Example 3. The bioreactor had an air supply of 30 L/min (0.2 VVM) and held at 26° C. The culture was harvested in 2 days upon successful visible (mycelial pellets) and microscope checks. The pH of the culture did not change during processing but the DO dropped by 25%. The culture was plated on LB media to ascertain the extent of any bacterial contamination and none was observed. The culture was then pasteurized at 82° C. for 30 minutes with a ramp up time of 30 minutes and a cool down time of 90 minutes to 10° C. The culture was finally concentrated to 20% solids, spray dried and tasted. The final product was noted to have a mild aroma with no perceptible taste at concentrations up to 10%. The product was 75% protein on a dry weight basis.

The amount of lactic acid in the final product (Product Batch 1 and 2 are from to different fermentation runs) were as follows, as shown in Table 2:

TABLE 2

| Product | Lactic Acid |
|---|---|
| Batch | (g/L) |
| 1 | 0.13 |
| 2 | 0.14 |

### Example 6

Eight (8) 1 L baffled DeLong Erlenmeyer flasks were filled with 0.4 L of media consisting of 45 g/L pea protein concentrate (labeled as 80% protein), 45 g/L rice protein concentrate (labeled as 80% protein), 1 g/L carrot powder, 1 g/L malt extract, 1.8 g/L diammonium phosphate and 0.7 g/L magnesium sulfate heptahydrate and sterilized in an autoclave being held at 120-121° C. for 90 minutes. The flasks were then carefully placed into a laminar flowhood and cooled for 18 hours. Each flask was inoculated with 24 mL of culture as prepared Example 2 except the strains used were G. lucidum, C. sinensis, I. obliquus and H. erinaceus, with two flasks per species. The flasks were shaken at 26° C. at 120 RPM with a 1″ swing radius for 8 days, at which point they were pasteurized as according to the parameters discussed in Example 5, desiccated, pestled and tasted. The G. lucidum product contained a typical ‘reishi’ aroma, which most of the tasters found pleasant. The other samples were deemed pleasant as well but had more typical mushroom aromas.

As compared to the control, the pasteurized, dried and powdered medium not subjected to sterilization or myceliation, the resulting myceliated food products was thought to be much less bitter and to have had a more mild, less beany aroma that was more cereal in character than beany by 5 tasters. The sterilized but not myceliated product was thought to have less bitterness than the nonsterilized control but still had a strong beany aroma. The preference was for the myceliated food product.

### Example 7

### Fermentation Operation in 10,000 L Fermenter

A 10,000-L bioreactor was prepared with the following medium components for a working volume of 6,200 L. pea protein 45 g/l, rice protein 45 g/l, maltodextrin 3.6 g/l, carrot powder 1.8 g/l, magnesium sulfate 0.72 g/l, di ammonium phosphate 1.8 g/l, citric acid 0.6 g/l, and 1.25 g/l of anti-foam added at the end of the charge. Medium was sterilized for 2 hours at 126° C. Medium was inoculated from 2000 L fermenter with a volume of 300-350 L.The aeration was maintained between 0.13 vvm and 0.25 vvm. Agitation was maintained to get a tip speed of 0.88 m/sec. Additional anti-foam of 0.25 g/l was added to contain the foaming. pH of the medium remained at 6.1 throughout the fermentation. Temperature for the fermentation as maintained at 26° C. Pressure in the fermenter was increased from 0.1 bar to 1.2 bar during the course of fermentation to minimize the foaming. Fermentation was completed in 45-50 hours. After completion of fermentation the fermented broth was pasteurized and concentrated to 20% and then spray dried.

The seed inoculum for the fermentation was prepared in a 2000 L fermentor with a working volume of 530-540 L with the following medium: pea protein 5 g/l, rice protein 5 g/l, maltodextrin 3.0 g/l, carrot powder 1 g/l, malt extract 3 g/l and 1.5 g/l of anti-foam. Organism was L. edodes. Fermentation pH was at 5.7 at the beginning of the fermentation. Fermentation was performed for 60 to 70 hours when pH reached between 4.6 and 4.9. The tip speed in the fermenter was maintained at 0.5-0.6 m/s. Aeration was done at 0.65-0.75 vvm. Fermenter was maintained at a pressure of 0.4-0.6 bar. Seed 1 for the inoculation of fermenter 2 was prepared in 150 L with a working volume of 55-65 L with the following medium: pea protein 5 g/l, rice protein 5 g/l, maltodextrin 3.0 g/l, carrot powder 1 g/l, malt extract 3 g/l, mango puree 3 g/l and 1.5 g/l of anti-foam. Fermentation pH was at 5.7 at the beginning of the fermentation. The tip speed in the fermenter was maintained at 0.69 m/s and pressure was maintained at 0.5 bar. Aeration was done at a rate of 0.75 vvm. The initial pH for the fermentation was at 5.7. Fermentation was completed between 45 and 55 hours. Inoculum for Seed 1 was prepared with the 5 flask prepared in 3 L flask with the following medium:: Pea Protein 5 g/l, Rice Protein 5 g/l, Maltodextrin 3.0 g/l, Carrot Powder 1 g/l, malt extract 3 g/l, mango puree 3 g/l and 1.25 g/l of anti-foam. Flask were inoculated with 4 cm² agar and incubated between 11 and 13 days. pH of the flask was obtained at 4 +/−2.

### Example 8

### Fermentation Operation in 180, 000 L Fermenter

The medium for 180,000 L bioreactor was prepared as a volume of 120,000 L with the following components: pea protein 45 g/l (labeled as 80% protein), rice protein 45 g/l (labeled as 80% protein), maltodextrin 3.6 g/l, carrot powder 1.8 g/l, magnesium sulfate 0.72 g/l, di ammonium phosphate 1.8 g/l, citric acid 0.6 g/l, and 1.25 g/l of anti-foam added at the end of the charge. The 180,000 L bioreactor was harvested at 48 hours.

The inoculum for the 180,000 L bioreactor was 6,200 L from a 10,000 L bioreactor prepared similar to the medium of Example 3. The 6,200 L bioreactor in turn was inoculated with 65 L of culture in a 150 L bioreactor prepared similar to the 6,200 L medium and was cultured to just before stationary phase. The 65 L medium was inoculated with flasks of Lentinula edodes in medium similar to that of the medium of Example 3 and cultured to stationary phase. These flasks had been inoculated with Lentinula edodes from the Penn State mushroom culture collection and culture to stationary phase.

### Example 9

### Sensory Data

Eight protein powders were tested: (a) raw material (3.2 pea); (b) raw material (pea); (c) raw material (rice); (d) raw material (rice); (e) myceliated material 3; (f) myceliated material 4; (g) myceliated material 4.2; and (h) myceliated material 3.2. Each protein powder was tested at 7% in water. Trained descriptive panelists used a consensus descriptive analysis technique to develop the language, ballot and rate profiles of the protein powders. The aroma language was as follows:

Overall aroma: the intensity of the total combined aroma; pea aroma, the aroma of dried peas/pea starch (reference; ground dried peas); beany aroma, the aroma of beans/bean starch (reference; ground dried lentils); rice aroma, the aroma of white rice (reference, cooked minute rice); mushroom aroma, the aroma of mushrooms (reference, dried shiitake mushrooms); overripe vegetable aroma, the aroma of soft overripe vegetables; and cardboard aroma, the aroma of pressed wet cardboard (reference: wet pressed cardboard).

The taste language was as follows: sweet, taste on the tongue stimulated by sugar in solution (reference, Domino Sugar in distilled water); sour, acidic taste on the tongue associated with acids in solution (reference, citric acid in distilled water); umami, the savory taste of MSG (reference; MSG in distilled water); bitter, basic taste on tongue associated with caffeine solutions (reference, caffeine powder in distilled water); astringent, the drying, puckering feeling associated with tannins (reference Mott's Apple Juice (40) Welch's Grape Juice (75)).

Flavor language was as follows: overall flavor, the composite intensity of all flavors as experienced while drinking the product; overripe vegetable, the flavor of soft overripe vegetables; pea, the flavor of dried peas/pea starch (reference: ground dried peas); beany, the flavor of beans/bean starch (reference: ground dried lentils; canned garbanzo beans); rice, the flavor of white rice (reference: cooked minute rice); mushroom, the flavor of mushrooms (reference: dried shiitake mushrooms); soapy, reminiscent of soap; chalky, the flavor associated with chalk and calcium (reference: citrucel gummies); cardboard, the flavor of pressed wet cardboard (reference: wet pressed cardboard); earthy, the flavor of fresh earth/dirt (reference: potting soil).

The raw pea product prior to myceliation has a pea aroma with no rice or mushroom aroma. The rice samples prior to myceliation have rice aroma with no pea or mushroom aroma. After myceliation, these samples have mushroom aroma and no pea or rice aroma, respectively. There is also increased umami flavor in the myceliated samples.

### Example 10

Eight (8) 1 L baffled DeLong Erlenmeyer flasks were filled with 0.500 L of the following 8 different media, after the manner of Example 1, see Table 3:

TABLE 3

| Component | Medium 1 | Medium 2 | Medium 3 | Medium 4 | Medium 5 | Medium 6 | Medium 7 | Medium 8 |
|---|---|---|---|---|---|---|---|---|
| Pea protein 1 | 54 | 54 | 49.5 | 54 | 54 | 54 | 0 | 54 |
| (g/L) | | | | | | | | |
| Chickpea powder | 36 | 36 | 22.5 | 36 | 36 | 36 | 36 | 36 |
| (g/L) | | | | | | | | |
| Rice protein (g/L) | 0 | 0 | 18 | 0 | 0 | 0 | 0 | 0 |
| Magnesium | 0.72 | 0.72 | 0.72 | 0.72 | 0.72 | 0.72 | 0.72 | 0.72 |
| sulfate (g/L) | | | | | | | | |
| Diammonium | 1.8 | 1.8 | 1.8 | 1.8 | 1.8 | 1.8 | 1.8 | 1.8 |
| phosphate (g/L) | | | | | | | | |
| Citric acid (g/L) | 1.5 | 1.5 | 1.5 | 1.5 | 0.6 | 0.9 | 1.5 | 1.5 |
| Carrot powder | 1.8 | 1.8 | 1.8 | 1.8 | 1.8 | 1.8 | 0 | 1.8 |
| (g/L) | | | | | | | | |
| Anti-foam 1 (g/L) | 1.25 | 0 | 1.25 | 1.25 | 1.25 | 1.25 | 1.25 | 1.25 |
| (organic polymer | | | | | | | | |
| based) | | | | | | | | |
| Pea protein 2 | 0 | 0.1 | 0 | 0 | 0 | 0 | 54 | 0 |
| (g/L) | | | | | | | | |
| Anti-foam 2 (g/L) | 0 | 0.1 | 0 | 0 | 0 | 0 | 0 | 0 |
| (silicone based) | | | | | | | | |
| Vegetable juice | 0 | 0 | 0 | 0 | 0 | 0 | 5 | 0 |
| (mL/L) | | | | | | | | |

The flasks were covered with a stainless-steel cap and steam sterilized. The flasks were carefully transferred to a clean HEPA laminar flow hood where they cooled for 4 hours and each were inoculated with 5% of 10-day old submerged Lentinula edodes. All 8 flasks were placed on a shaker table at 150 rpm with a swing radius of 1″ at room temperature and allowed to incubate for 3 days. Plating aliquots of each sample on LB and petri film showed no contamination in any flask. The pH changes during processing is shown below, and is essentially the same (within the margin of error of the pH meter). See Table 4.

TABLE 4

| Medium | pH, T = 0 | pH T = 3 days |
|---|---|---|
| 1 | 6.09 | 6.04 |
| 2 | 6.00 | 5.92 |
| 3 | 5.90 | 5.83 |
| 4 | 6.01 | 5.97 |
| 5 | 6.56 | 6.35 |
| 6 | 6.38 | 6.23 |
| 7 | 5.79 | 5.79 |
| 8 | 6.05 | 5.93 |

Top performing recipes in sensory from these 8 media were media 5 and 7. Bitterness and sourness were evaluated and these two media showed the best results, although all media exhibited reduced undesirable flavors and reduced aromas, such as reduced beany aroma, pea aroma, or rice aroma and reduced beany taste, pea taste, rice taste, and bitter taste. The sensory evaluation included 15 tasters, all tasting double-blind, randomized samples and providing a descriptive analysis. These recipes were further evaluated for strain screening work as described in Example 12.

### Example 11

A 7 L bioreactor was filled with 4.5 L of a medium consisting of the medium as described in following table (see Table 5):

TABLE 5

| Component | Medium 1 | Medium 2 | Medium 3 |
|---|---|---|---|
| Pea protein 1 (g/L) | 45 | 45 | 58.5 |
| Rice Protein (g/L) | 45 | 45 | 31.5 |
| Anti-foam 2 (g/L) | 1.25 | 1.25 | 1.25 |

In this experiment, excipients other than an anti-foam were omitted from the fermentation medium, and only rice protein, pea protein, and anti-foam were used as the medium. In previous examples, excipients such as magnesium sulfate, diammonium phosphate (which functions at least in part as a buffer), citric acid, carrot powder, were used and are omitted here. It was theorized that omission of these excipients will encourage the culture to convert protein metabolically and not proliferate. Open ports on the bioreactor were wrapped in foil and the vessel was subsequently sterilized in an autoclave. The bioreactors were carefully transferred to a clean bench in a cleanroom, setup and cooled for 4-6 hours. The bioreactor was inoculated with 5%, 10% and 7.5% of inoculant of L. edodes from a 12-day old flask. Fermentation for these batches was completed in 44 hours, 24 hours and 30 hours respectively for medium 1, medium 2 and medium 3. A microscope check was done to ensure the presence of mycelium (mycelial pellets were visible by the naked eye) and the culture was plated on LB media to ascertain the extent of any bacterial contamination and none was observed. These cultures were pasteurized for 60 minutes at 65° C. and organoleptic taste assessments were conducted. Following table summarizes the pH at the harvest (see Table 6):

TABLE 6

| Component | Medium 1 | Medium 2 | Medium 3 |
|---|---|---|---|
| pH t = 0 | 6.8 | 6.83 | 6.8 |
| pH Harvest | 6.56 | 6.68 | 6.58 |
| Delta pH | 0.24 | 0.15 | 0.22 |
| Harvest time | 24 | 30 | 44 |
| (hours) | | | |

Microscopic examination of these different inoculum and protein samples was done and it suggested growth even for medium 1 at 24 hours fermentation. Another interesting finding for this study was a modest pH change of up to 0.25 units. This could be explained by the fact that the medium omitted the buffering compound diammonium phosphate from the medium.

Bitterness and sourness were evaluated and these two media showed the best results, although all media exhibited reduced beany aroma, pea aroma, or rice aroma and reduced beany taste, pea taste, rice taste, and bitter taste.

### Example 12

A 7 L bioreactor was filled with 4.5 L of a medium consisting of the medium as described in following Table 7:

TABLE 7

| | Medium |
|---|---|
| Component | 1 |
| Pea protein 1 (g/L) | 58.5 |
| Rice Protein (g/L) | 31.5 |
| Carrot Powder (g/L) | 1.8 |
| Leucine(g/L) | 3.5 |
| Maltodextrin (g/L) | 3.6 |
| Antifoam IP 3500 | 0.75 |
| (g/L) | |

It was found that in the combination of pea protein and rice protein 58.5 g/L and 31.5 g/L had a leucine content of about 8.8 g/100 g total protein. In order to bring the total content of BCAA to the desired level of about 12.5-13% by weight (protein) branched chain amino acids, 3.5 g/L leucine was added to the media. The fermentations were then carried out in the process as discussed in Examples 2-4, except the recipe used was the one given in Table 7 and the inoculant was as described below. In brief, the open ports on the bioreactor were wrapped in foil and the vessel was subsequently sterilized in an autoclave. The bioreactors were carefully transferred to a clean bench in a cleanroom, setup and cooled for 4-6 hours. The bioreactor was inoculated with 4% total volume of the bioreactor of inoculant of L. edodes from a 12-day old flask. Fermentation for these batches was completed in 20 hours, 24 hours and 27 hours, respectively. A microscope check was done to ensure the presence of mycelium (mycelial pellets are visible by the naked eye) and the culture was plated on LB media to ascertain the extent of any bacterial contamination and none was observed. These cultures were pasteurized for 60 minutes at 70C. ° C. and organoleptic taste assessments were conducted. Following samples were evaluated:

Reference. The reference is prepared as described in Examples 2-5, and “spiked” with leucine to a level of 12.5-13% by weight protein.

A: Protein prepared as described in Examples 2-5, no added leucine.

B: Protein prepared as described in this Example, 20 hour fermentation.

C: Protein prepared as described in this Example, 24 hour fermentation.

D: Protein prepared as described in this Example, 27 hour fermentation.

For sensory evaluation, all samples were first tasted using descriptive analysis. Tasters were asked to capture everything they sensed, focusing on flavor notes, texture, off-notes, and any other sensory sensations. Then through consensus, key sensory attributes pertaining to the sample set are listed and scored on much more or less individual attributes are relative to the reference sample. Lastly, each taster is asked which sample was most preferred and what the deciding factor was.

Overall, A was still deemed preferable over any of the leucine added samples. This was because of the noticeable bitterness and isovaleric notes (rancid, vomit notes) were detected in the leucine added fermented samples. The BCAA bitterness and isovaleric notes were overall higher (in various degrees) in Reference than in the samples B, C, and D. In other words, fermented samples made by the methods of the invention showed reduced bitterness and reduced undesirable isovaleric acid notes. Bitterness was decreased, as well as isovaleric aroma, compared to a control with supplemented leucine without a fermentation step as described herein (data not shown).

Of all leucine supplemented medium, 27 hour fermentation was the most preferred with it being the closest to neutral taste, and increased creamy texture. No mushroom notes are detected in any of the fermentation supplemented with leucine.

### Example 13

A 7 L bioreactor was filled with 4.5 L of a medium consisting of the medium as described in following Table 8.

TABLE 8

| | Medium |
|---|---|
| Component | 1 |
| Pea protein 1 (g/L) | 58.5 |
| Rice Protein (g/L) | 31.5 |
| Carrot Powder (g/L) | 1.8 |
| Leucine(g/L) | 3.5 |
| Maltodextrin (g/L) | 3.6 |
| Antifoam IP 3500 | 0.75 |
| (g/L) | |

It was found that in the combination of pea protein and rice protein 58.5 g/L and 31.5 g/L had a leucine content of about 8.8 g/100 g total protein. In order to bring the total content of BCAA to the desired level of about 12.5-13% by weight (protein) branched chain amino acids, 3.5 g/L leucine was added to the media. The fermentations are then carried out in the process as discussed in Examples 2-4, except the recipe used is the one given in Table 8 and the inoculant is as described below. In brief, the open ports on the bioreactor were wrapped in foil and the vessel was subsequently sterilized in an autoclave. The bioreactors were carefully transferred to a clean bench in a cleanroom, setup and cooled for 4-6 hours. The bioreactor was inoculated with 4% total volume of the bioreactor of inoculant of L. edodes from a 12-day old flask. Fermentation for these batches was completed in 27 hours, 30 hours and 33 hours, respectively. A microscope check was done to ensure the presence of mycelium (mycelial pellets are visible by the naked eye) and the culture was plated on LB media to ascertain the extent of any bacterial contamination and none is observed. These cultures were pasteurized for 60 minutes at 70° C. and organoleptic taste assessments were conducted. Following samples are evaluated:

Reference. The reference was prepared as described in Examples 2-5, and “spiked” with leucine to a level of 12.5-13% by weight protein.

A: Protein prepared as described in Examples 2-5, no added leucine.

B: Protein prepared as described in this Example, 27 hour fermentation.

C: Protein prepared as described in this Example, 30 hour fermentation.

D: Protein prepared as described in this Example, 33 hour fermentation.

Comparing fermentations, e.g., the 27 hour, 30 hour, and 33 hour fermentations, the 30 hour fermentation had reduced bitterness and reduced isovaleric notes from 27 hour fermentation. The 30 hour fermentation also maintained a creamy flavor and texture. The fermented batch in 33 hours had similar reduction in bitterness and isovaleric notes as 30 hours, but increased sour notes and chalkiness caused some irritation in the back throat. Therefore 3 of the 5 tasters concluded that the 30 hour fermentation as the most preferred sample. Bitterness was decreased, as well as isovaleric aroma, compared to a control with supplemented leucine without a fermentation step as described herein (data not shown).

### Example 14

A 7 L bioreactor was filled with 4.5 L of a medium consisting of the medium as described in following table. No maltodextrin was added. See Table 9.

TABLE 9

| | Medium |
|---|---|
| Component | 1 |
| Pea protein 1 (g/L) | 58.5 |
| Rice Protein (g/L) | 31.5 |
| Carrot Powder (g/L) | 1.8 |
| Leucine(g/L) | 3.5 |
| Antifoam IP 3500 | 0.75 |
| (g/L) | |

The fermentations were performed as described in Examples 12 and 13. Comparing control without leucine to 30 hour and 33 hour fermentation, 30 hour fermentation maintained a creamy flavor and texture present amongst all leucine added samples. The fermented batch in 33 hours had similar reduction in bitterness and isovaleric notes as 30 hours, but increased sour notes and chalkiness causes some irritation in the back throat. Therefore medium leucine at 30 hour fermentation is the most preferred sample. Bitterness was decreased, as well as isovaleric aroma, compared to a control with supplemented leucine without a fermentation (data not shown).

### Example 15

A 250 L bioreactor was filled with 150 L of a medium consisting of 58.5 g/L of pea powder, 31.5 g/L rice powder, 3.6 g/l of maltodextrin powder, 1.8 g/L g of carrot powder,3.5 g/l of leucine powder and 0.75 g/l of IP-3500 antifoam and sterilized in place by methods known in the art, being held at 120-121° C. for 100 minutes. The bioreactor was inoculated with 6 L of inoculant from four 4 L flasks. The bioreactor had an air supply of 23L/min (0.2 VVM) and held at 26° C. Samples were taken at 30 and 33 hours for organoleptic tasting. The culture was harvested at 33 hours upon successful visible (mycelial pellets) and microscope checks. The pH of the culture did not change during processing but the DO dropped by 15%. The culture was plated on LB media to ascertain the extent of any bacterial contamination and none was observed. The culture was then pasteurized at 70° C. for 60 minutes with a ramp up time of 30 minutes and a cool down time of 45 minutes to 10° C. The culture was finally spray dried and tasted. The final product was noted to have a pleasant aroma with no bitter or isovaleric taste at concentrations up to 7%.

Comparing the no leucine added control to the leucine added materials undergoing 30 hour and 33 hour fermentation, 30 hour fermentation maintained a creamy flavor and texture present amongst all leucine added samples. The fermented batch in 33 hours had similar reduction in bitterness and isovaleric notes as 30 hours, but increased sour notes and chalkiness caused some irritation in the back throat. Therefore 30 hour fermentation was the most preferred sample. Bitterness was decreased, as well as isovaleric aroma, compared to a control with supplemented leucine without a fermentation step as described herein (data not shown).

### Example 16

Two 7 L bioreactor was filled with 4.5 L of a medium consisting of the medium as described in following table. No maltodextrin was added. However, leucine was added at the increased concentration of 4.6 g/l and 5/8 g/l as shown in Table 10.

TABLE 10

| Component | Medium 1 | Medium 2 |
|---|---|---|
| Pea protein 1 (g/L) | 58.5 | 58.5 |
| Rice Protein (g/L) | 31.5 | 31.5 |
| Carrot Powder (g/L) | 1.8 | 1.8 |
| Leucine (g/L) | 4.6 | 5.8 |
| Antifoam IP 3500 (g/L) | 0.75 | 0.75 |

The fermentations were performed as described in Examples 12, 13, and 14 except that fermentation time was increased to 38 hours. Sensory was done and also compared with non-leucine supplemented control and supplemented leucine control at lower concentration of 3.5 g/l for 30 hours. The results are as summarized in Table 11:

TABLE 11

| | |
|---|---|
| Reference: 3.5 g/l leucine 30 Hrs | Slightly cheesy, slight irritation. |
| 4.6 g/L Leucine | Sour, astringent, umami. |
| 5.8 g/L Leucine | Savory, umami, sour, salty. |
| Non-supplemented control | Mouth-coat, earthy, barn-y. |

The results for 4.6 g/l of leucine added medium showed more sour, umami, and astringency. Likewise, 5.8 g/l leucine added sample introduced savory and saltiness in addition to sour and umami. Bitterness was decreased, as well as isovaleric aroma, compared to a control with supplemented leucine without a fermentation (data not shown). Despite detected sourness, the overall flavor profile was acceptable via small group consensus for both concentrations of leucine as compared to 30 hours control with 3.5 g/l added leucine. Bitterness was decreased, as well as isovaleric aroma, compared to a control with supplemented leucine without a fermentation step as described herein (data not shown). Glucose, yeast extract, sunflower lecithin in olive oil grown inoculum (described in Example 17 below was used for these studies.

### Example 17

The medium for 90,000 L bioreactor was prepared as a volume of 30,000 L with the following components, shown in Table 12:

TABLE 12

| Component | Medium 1 |
|---|---|
| Pea protein 1 (g/L) | 58.5 |
| Rice Protein (g/L) | 31.5 |
| Carrot Powder (g/L) | 1.8 |
| Magnesium sulfate (g/L) | 2.4 |
| Calcium Chloride ( g/L) | 2.1 |
| Leucine (g/L) | 5.6 |
| Antifoam IP 3500 (g/L) | 0.75 |

The 90,000 L bioreactor was harvested at 36 hours.

The inoculum for the 90,000 L bioreactor was 3,700 L from a 4,500 L bioreactor prepared similar to the medium containing the following.

Glucose 50 g/l

Yeast extract 5 g/l

Sunflower Lecithin 1 ml/l

Fermentation was continued until pH dropped to 3.7 from initial pH of 5.2+/−0.1

The 4,500 L bioreactor in turn was inoculated with 300 L of culture in a 400 L bioreactor prepared similar to the 4,500 L medium and was cultured to get pH of 3.7. The 25 L medium was inoculated with flasks of Lentinula edodes in medium similar to that of the medium of 4,500 and cultured to pH of 3.7. These flasks had been inoculated with Lentinula edodes from the Penn State mushroom culture collection in the same medium used for 4,500 L and cultured to pH 4-4.3.

The medium for the main fermenter is shown in Table 13.

TABLE 13

| Component | Medium 1 |
|---|---|
| Pea protein 1 (g/L) | 58.5 |
| Rice Protein (g/L) | 31.5 |
| Carrot Powder (g/L) | 1.8 |
| Magnesium sulfate (g/L) | 2.4 |
| Calcium Chloride ( g/L) | 2.1 |
| Leucine (g/L) | 5.6 |
| Antifoam IP 3500 (g/L) | 0.75 |

The tasting notes for this Example were as follows, see Table 14. Bitterness was decreased, as well as isovaleric aroma, compared to a control with supplemented leucine without a fermentation (data not shown).

TABLE 14

| | |
|---|---|
| Sample # Example 17 | Chalky, less bitter, umami, salty, sour. |
| Sample # Blind Control | Chalky, bitter, umami, slight mushroom, |
| (reference) | salty, sour. |

### Example 18

Two 7 L bioreactor was filled with 4.5 L of a medium consisting of the medium as described in following table. Methionine was added as shown in Table 15.

TABLE 15

| Component | Medium 1 | Medium 2 |
|---|---|---|
| Pea protein (g/L) | 58.5 | 58.5 |
| Rice Protein (g/L) | 31.5 | 31.5 |
| Carrot Powder (g/L) | 1.8 | 1.8 |
| Maltodextrin(g/L) | 3.6 | 3.6 |
| Methionine (g/L) | 0.35 | 0.75 |
| Antifoam IP 3500 (g/L) | 0.75 | 0.75 |

The fermentations are performed as described in Example 16 but using the recipe shown in this Example. A methionine-supplemented material at high amounts (>0.7 mg/g protein exogenous methionine), without fermentation, was described as bitter, salty, metallic, cooked cabbage, fishy; upon fermentation with either amount supplemented, 0the material was described as having reduced bitter, salty, metallic flavors, and was described as having flavor characteristics of upfront umami, salty, low cabbage (weak), low fishy (weak), very low bitter, milky/cream, umami linger.

### Example 19

Added lysine. Three 7 L bioreactor was filled with 4.5 L of a medium as described in following table 16, fermentation was carried out using the same method as described in Example 15.

TABLE 16

| Component | Medium 1 | Medium 2 | Medium 3 |
|---|---|---|---|
| Pea protein (g/L) | 58.5 | 58.5 | 58.5 |
| Rice Protein (g/L) | 31.5 | 31.5 | 31.5 |
| Carrot Powder (g/L) | 1.8 | 1.8 | 1.8 |
| Maltodextrin(g/L) | 3.6 | 3.6 | 3.6 |
| Lysine (g/L) | 5.2 | 5.6 | 6.8 |
| Antifoam IP 3500 (g/L) | 0.75 | 0.75 | 0.75 |

After the fermentation process was finished with medium 1, the resultant material was used to make a bread by methods known in the art, using the recipe shown in Table 17 below. The sensory in Table 18 shows that the bitter taste added by lysine addition (data not shown) was moderated by the fermentation process. “Pea and Rice fermented Protein” refers to protein made by the method of Example 2-4 or this Example 19. Table 18 provides the sensory characteristics of the breads made by the methods of the invention.

TABLE 17

| Ingredient | % | grams |
|---|---|---|
| Bread flour | 47.02% | 399.65 |
| Pea and Rice fermented | 5.00% | 42.50 |
| protein ± lysine | | |
| Sugar, white, cane | 5.22% | 44.41 |
| Vegetable shortening, | 1.63% | 13.87 |
| crisco | | |
| Salt | 0.85% | 7.21 |
| Vital wheat gluten | 3.53% | 29.96 |
| Yeast, fast acting | 0.85% | 7.21 |
| water | 35.90% | 305.19 |
| Total | 100.000% | 850 |

TABLE 18

| | |
|---|---|
| Sample: | Sweet, slight flavor, chalky aftertaste. |
| −Lysine | Tastes mostly like a white bread with slight protein end. |
| Bread | More neutral in flavor; lower flavor impact. |
| Sample: | Less sweet, more grain flavor, very |
| +Lysine | slight bitter linger, vitamin taste. |
| Bread | More roasted taste (possible |
| | baking variation). Protein flavor is low. |
| | More flavorful bread. |
| | There is a consensus that this product is consumer acceptable. |

### Example 20

Two protein compositions were tested in pigs, these proteins included a pea-rice protein blend (no fermentation) and fermented pea/rice protein (prepared by the methods of Examples 2-4). Three diets were formulated with the test proteins included in one diet each as the only amino acid (AA) containing ingredient. The third diet was a nitrogen-free diet that was used to measure basal endogenous losses of crude protein (CP) and AA. Vitamins and minerals were included in all diets to meet or exceed current requirement estimates for growing pigs (National Research Council; NRC, 2012). All diets also contained 0.4% titanium dioxide as an indigestible marker, and all diets were provided in meal form. Nine growing barrows (initial BW: 28.5±2.3 kg) were equipped with a T-cannula in the distal ileum (Stein et al., 1998) and allotted to a triplicated 3×3 Latin square design with 3 pigs and 3 periods in each square. Diets were randomly assigned to pigs in such a way that within each square, one pig receive each diet, and no pig received the same diet twice during the experiment. Therefore, there were 9 replicate pigs per treatment for the 3 Latin squares. Pigs were housed in individual pens (1.2×1.5 m) in an environmentally controlled room. Pens had have smooth sides and fully slatted tribar floors. A feeder and a nipple drinker were also installed in each pen. All pigs were fed their assigned diet in a daily amount of 3.3 times the estimated energy requirement for maintenance (i.e., 197 kcal ME per kg0.60; NRC, 2012). Two equal meals were provided every day at 0800 and 1600 h, and water was available at all times. Pig weights were recorded at the beginning and at the conclusion of the experimental period, and the amount of feed supplied each day was recorded. The experimental period was 9 d, with the initial 5 d considered an adaptation period to the diet. Fecal samples were collected in the morning of d 6, 7, and 8 by anal stimulation and immediately frozen at −20° C. Ileal digesta were collected for 9 hours (from 0800 to 1700 h) on d 8 and 9 following standard operating procedures (Stein et al., 1998). In short, a plastic bag was attached to the cannula barrel and digesta flowing into the bag were collected. Bags were removed once filled with ileal digesta, or at least once every 30 minutes, and immediately frozen at −20° C. to prevent bacterial degradation of AA in the ileal digesta.

At the conclusion of the experiment, ileal samples were thawed, mixed within animal and diet, and a sub-sample was collected for chemical analysis. Ileal digesta samples were lyophilized and finely ground prior to chemical analysis. Fecal samples were dried in a forced-air oven and ground through a 1 mm screen in a Wiley Mill (model 4, Thomas Scientific) prior to chemical analysis. All samples were analyzed for dry matter (DM; Method 927.05; AOAC International, 2007) and for CP by combustion (Method 990.03; AOAC International, 2007) at the Monogastric Nutrition Laboratory at the University of Illinois. The analysis for DM and CP were repeated if the analyzed values are more than 2% apart. All diets, fecal samples, and ileal digesta were analyzed in duplicate for titanium (Method 990.08; Myers et al., 2004). The Mycotech ingredients, all diets, and ileal digesta samples were also be analyzed for AA [Method 982.30 E (a, b, c); AOAC International, 2007].

Values for apparent ileal digestibility (AID) and standardized ileal digestibility (SID) of CP and AA were calculated (Stein et al., 2007), and standardized total tract digestibility (STTD) of CP were calculated as well (Mathai et al., 2017). Average values for basal endogenous losses of CP and AA used to calculate SID values (Sotak-Peper et al., 2017), in addition, an average value for basal endogenous losses of CP were calculated from 2 previously conducted experiments in our laboratory to calculate STTD. Values for PDCAAS were calculated from the standardized total tract digestiblity of crude protein in pigs: pea-rice protein, 94.59%; fermented pea/rice protein, 99.90%. The standardized total tract digestiblity of crude protein was calculated by correcting apparent total tract digestiblity (ATTD) of crude protein for the basal endogenous loss of CP, 16.61 g/kg dry matter intake. The ATTD of crude protein for pea-rice protein was 82.72% and 88.44% for fermented protein.

### Example 21

### Blood Plasma Studies

The objective of this work is to determine the absorption rate of amino acids (BCAA) in material prepared according to Example 17 compared with material prepared in accordance with Examples 2-5 (control), when fed to pigs. A total of 16 pigs (approximate initial BW: 12-15 kg) are allotted to 2 diets. Therefore, there are 8 replicate pigs per dietary treatment. Vitamins and minerals are included in all diets to meet or exceed current requirement estimates (NRC, 2012).

Pigs are placed in individual pens that are equipped with a feeder, a nipple watered, and slatted floors. Pigs are limit fed at 3.4 times the energy requirement for maintenance (i.e., 197 kcal/kg×BW0.60; NRC, 2012), which is provided each day in 2 equal meals at 0800 and 1600 h. Throughout the study, pigs have ad libitum access to water. Feed allotments are recorded daily and pigs are fed experimental diets for 7 days. The initial 6 days are considered the adaptation period to the diet. However, on d 7, blood samples are collected from the jugular vein of each pig immediately before the morning meal, and again 30 min, 60 min, 120 min, 180 min, 6 h, and 9 h after feeding the morning meal. Samples are collected in vacutainers and centrifuged at 1,500×g at 4° C. for 15 min to recover the plasma. All samples are then stored at −20° C. until analyzed for AA. All diets are analyzed for DM (dry matter), CP (crude protein), and AA (amino acid).

Data is analyzed with the PROC MIXED function in SAS (SAS Institute Inc., Cary, NC) with the pig as the experimental unit. Homogeneity of the variances are confirmed using the UNIVARIATE procedure in PROC MIXED and outliers are identified and removed as values that deviate from the treatment mean by more than 3 times the interquartile range. Least squares means are calculated using a Least Significant Difference test and means are separated using the PDIFF statement in PROC MIXED. Results are considered significant at P≤0.05 and considered a trend at P≤0.10. The blood amino acid profile shows BCAA increase over the control and close to whey protein.

### STATEMENTS REGARDING INCORPORATION BY REFERENCE AND VARIATIONS

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments, exemplary embodiments and optional features, modification and variation of the concepts herein disclosed may be resorted to by those skilled in the art, and that such modifications and variations are considered to be within the scope of this invention as defined by the appended claims. The specific embodiments provided herein are examples of useful embodiments of the present invention and it will be apparent to one skilled in the art that the present invention may be carried out using a large number of variations of the devices, device components, methods steps set forth in the present description. As will be obvious to one of skill in the art, methods and devices useful for the present methods can include a large number of optional composition and processing elements and steps.

Whenever a range is given in the specification, for example, a temperature range, a time range, or a composition or concentration range, all intermediate ranges and subranges, as well as all individual values included in the ranges given are intended to be included in the disclosure. It will be understood that any subranges or individual values in a range or subrange that are included in the description herein can be excluded from the claims herein.

All patents and publications mentioned in the specification are indicative of the levels of skill of those skilled in the art to which the invention pertains. References cited herein are incorporated by reference herein in their entirety to indicate the state of the art as of their publication or filing date and it is intended that this information can be employed herein, if needed, to exclude specific embodiments that are in the prior art. For example, when composition of matter are claimed, it should be understood that compounds known and available in the art prior to Applicant's invention, including compounds for which an enabling disclosure is provided in the references cited herein, are not intended to be included in the composition of matter claims herein.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” may be replaced with either of the other two terms. The invention illustratively described herein suitably may be practiced in the absence of any element or elements, limitation or limitations which is not specifically disclosed herein.

One of ordinary skill in the art will appreciate that starting materials, biological materials, reagents, synthetic methods, purification methods, analytical methods, assay methods, and biological methods other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

We claim:

1. A method to prepare a myceliated amino-acid-supplemented high-protein food product, comprising the steps of:
providing an aqueous medium comprising a high-protein material, wherein the aqueous medium comprises at least 50% (w/w) protein on a dry weight basis, wherein the media comprises at least 50 g/L protein, wherein the media is supplemented with at least one exogenous amino acid in an amount that results in an increase in the total wt % of the at least one amino acid in the high-protein material by at least 1%, and wherein the high protein material is from a plant source;
inoculating the medium with a fungal culture, wherein the fungal culture comprises Lentinula edodes, Agaricus spp., Pleurotus spp., Boletus spp., or Laetiporus spp., and
culturing the medium to produce a myceliated amino acid-supplemented high-protein food product;
wherein the myceliated amino acid-supplemented high-protein food product has reduced bitterness and/or reduced volatile amino-acid-derived aroma compared to the high-protein amino acid-supplemented material that is not myceliated.

2. The method of claim 1, wherein the exogenous amino acid comprises a branched chain amino acid (BCAA).

3. The method of claim 2, wherein the at least one BCAA comprises leucine.

4. The method of claim 2, wherein the reduced volatile amino-acid derived aroma is a fatty acid aroma.

5. The method of claim 3, wherein the amount of exogenous leucine is added to a final level of at least about 140 g/g protein in the supplemented high-protein material.

6. The method of claim 1, wherein the exogenous amino acid is a sulfur-containing amino acid (SAA).

7. The method of claim 6, wherein the SAA is methionine.

8. The method of claim 7, wherein the amount of exogenous methionine added provides a PDCAAS of at least about 0.95 to the supplemented high-protein material, and wherein the supplemented high-protein material is pea protein concentrate.

9. The method of claim 1, wherein the exogenous amino acid comprises lysine.

10. The method of claim 9, wherein the amount of added exogenous lysine brings the amount of lysine to at least 100 mg/g protein.

11. The method of claim 1, wherein the Laetiporus spp. is Laetiporus sulfureus.

12. The method of claim 1, wherein the Pleurotus spp. comprises Pleurotus ostreatus, Pleurotus salmoneostramineus (Pleurotus djamor), Pleurotus eryngii, or Pleurotus citrinopileatus.

13. The method of claim 1, wherein the Pleurotus spp. comprises Pleurotus ostreatus or Pleurotus salmoneostramineus (Pleurotus djamor).

14. The method of claim 1, wherein the Boletus spp. comprises Boletus edulis and Agaricus spp. comprises Agaricus blazeii, Agaricus bisporus, Agaricus campestris, Agaricus subrufescens, Agaricus brasiliensis or Agaricus silvaticus.

15. The method of claim 1, wherein the fungal culture is a submerged fungal culture.

16. The method of claim 1, wherein the high-protein material is at least 70% (w/w) protein on a dry weight basis.

17. The method of claim 1, wherein the aqueous media comprises between 50 g/L protein and 200 g/L protein.

18. The method of claim 1, wherein the high-protein material is a protein concentrate or a protein isolate.

19. The method of claim 18, wherein the high-protein material is from a plant source.

20. The method of claim 19, wherein the plant source comprises pea, rice, or combinations thereof

21. The method of claim 1, wherein the myceliated amino acid-supplemented high-protein food product is sterilized or pasteurized prior to the inoculating step.

22. The method of claim 1, wherein the method further comprises the step of drying the myceliated amino acid-supplemented high-protein food product.

23. The method of claim 1, wherein the myceliated amino acid-supplemented high-protein food product has decreased bitterness.

24. The method of claim 1, wherein the media is supplemented with at least one amino acid in an amount that results in an increase in the total wt % of the at least one amino acid in the high-protein material by at least 2%.

25. The method of claim 1, wherein the media is supplemented with at least one amino acid in an amount that results in an increase in the total wt % of the at least one amino acid in the high-protein material by at least 3%.

26. The method of claim 1, wherein the media is supplemented with at least one amino acid to result in a final level of at least 12% wt % of the at least one amino acid.

27. The method of claim 1, wherein the pH of the fungal culture during the culturing step has a change of less than 0.5 pH units during the myceliation step.

28. The method of claim 25, wherein the pH of the fungal culture during the culturing step has a change of less than 0.3 pH units during the myceliation step.

29. The method of claim 1, wherein the culturing step is carried out until the dissolved oxygen in the media reaches between 80% and 90% of the starting dissolved oxygen.

30. A myceliated amino acid-supplemented food product made by the method of claim 1.

31. A composition comprising a myceliated amino acid-supplemented high-protein food product, wherein the myceliated amino acid-supplemented high-protein food product is at least 50% (w/w) protein on a dry weight basis, wherein the myceliated amino acid-supplemented high protein food product is derived from a plant source, wherein the myceliated amino acid-supplemented high protein product is myceliated by a fungal culture comprising Lentinula edodes, Agaricus blazeii, Pleurotus spp., Boletus spp., or Laetiporus spp. in a media comprising at least 50 g/L protein, wherein the amino acid-supplemented high-protein food product has additional exogenous amino acid in an amount that is an increase in the total wt % of amino acid over the original endogenous amount of at least 1% and wherein the myceliated amino acid-supplemented high protein food product has reduced bitterness and/or reduced volatile amino acid derived aroma compared with a non-myceliated amino acid-supplemented food product.

32. The composition of claim 31, wherein the myceliated amino acid-supplemented high-protein food product is at least 70% (w/w) protein on a dry weight basis.

33. The composition of claim 31, wherein the plant source is pea, rice, or combinations thereof.

34. The composition of claim 31, wherein the myceliated amino acid-supplemented high-protein food product is in the form of a powder.

35. The composition of claim 31, wherein the myceliated amino acid-supplemented high-protein food product is produced according to the method of claim 1.

36. A method to prepare a myceliated amino acid-supplemented high-protein food composition, comprising the steps of:
(a) providing a myceliated amino acid-supplemented high protein food product, comprising:
(i) providing an aqueous medium comprising a high-protein material, wherein the aqueous medium comprises at least 50% (w/w) protein on a dry weight basis, wherein the media comprises at least 50 g/L protein, wherein the media is supplemented with at least one amino acid in an amount that results in an increase in the total wt % of the at least one amino acid in the high-protein material by at least 1%, and wherein the high protein material is from a plant source;
(ii) inoculating the medium with a fungal culture, wherein the fungal culture comprises Lentinula edodes, Agaricus spp., Pleurotus spp., Boletus spp., or Laetiporus spp., and
(iii) culturing the medium to produce a myceliated amino acid-supplemented high-protein food product;
wherein the myceliated amino acid-supplemented high-protein food product has reduced bitterness and/or reduced volatile amino acid-derived fatty acid flavor compared to the high-protein amino acid-supplemented material that is not myceliated;
(b) providing an edible material; and
(c) mixing the myceliated amino acid-supplemented high-protein food product and the edible material to form the food composition.

37. The method of claim 36, further comprising a cooking step and an extrusion step using an extruder.

38. The method of claim 37, further comprising a puffing step.

39. The method of claim 36, wherein the edible material comprises a starch, a flour, a grain, a lipid, a colorant, a flavorant, an emulsifier, a sweetener, a vitamin, a mineral, a spice, a fiber, a protein powder, nutraceuticals, sterols, isoflavones, lignans, glucosamine, an herbal extract, xanthan, a gum, a hydrocolloid, a starch, a preservative, a legume product, a food particulate, and combinations thereof.

40. The method of claim 39, wherein the food particulate is selected from the group consisting of cereal grains, cereal flakes, crisped rice, puffed rice, oats, crisped oats, granola, wheat cereals, protein nuggets, texturized plant protein ingredients, flavored nuggets, cookie pieces, cracker pieces, pretzel pieces, crisps, soy grits, nuts, fruit pieces, corn cereals, seeds, popcorn, yogurt pieces, and combinations of any thereof.

41. The method of claim 36, wherein the food composition is selected from the group consisting of dairy alternative products, ready to mix beverages and beverage bases; extruded and extruded/puffed products; sheeted baked goods; meat analogs and extenders; baked goods and baking mixes; granola; and soups/soup bases.

42. A food composition made by the method of claim 36, wherein the food composition is selected from the group consisting of reaction flavors, dairy alternative products, ready to mix beverages and beverage bases; extruded and extruded/puffed products; sheeted baked goods; texturized plant-based protein products; baked goods and baking mixes; granola; and soups/soup bases.

43. The method of claim 36, wherein the method additionally comprises
(d) adding steam and/or water to the mixture;
(e) extruding the mixture under heat and pressure to form a textured plant-based protein product, wherein the edible material comprises an additional high protein material, and wherein the myceliated high-protein food product is present at between about 5% and 90% on a dry weight basis compared with the edible material.

44. The method of claim 43, wherein the method further comprises providing a starch or a fiber prior to the mixing step.
